(19) United States
(12) Patent Application Publication
(10) Pub. No.: US 2026/0327351 A1
(43) Pub. Date: Oct. 22, 2026

(54) CATALYSTS, POLYETHYLENES, POLYMERIZATIONS THEREOF, AND FILMS THEREOF

(71) Applicant: EXXONMOBIL TECHNOLOGY AND ENGINEERING COMPANY, Spring, TX (US)

(72) Inventors: Laughlin G. McCullough, League City, TX (US); Matthew W. Holtcamp, Humble, TX (US); Ali H. Slim, Houston, TX (US); Kevin A. Stevens, Raritan, NJ (US); Irene C. Cai, Webster, TX (US)

(73) Assignee: EXXONMOBIL TECHNOLOGY AND ENGINEERING COMPANY, Spring, TX (US)

(21) Appl. No.: 19/485,633

(22) PCT Filed: May 14, 2024
(86) PCT No.: PCT/US2024/029268

§ 371 Date: Nov. 18, 2025

Related U.S. Application Data
(60) Provisional application No. 63/503,915, filed on May 23, 2023.

(51) Int. Cl. C08F 4/6592; C08F 210/16

(52) U.S. Cl. CPC C08F 4/65925; C08F 210/16; C08F 2410/01; C08F 2420/03; C08F 2420/04; C08F 2500/09; C08F 2800/20

(57) ABSTRACT

The present disclosure relates to catalysts, catalyst systems, polyethylene polymers, polymerization processes for making such polyethylene polymers, and films made therefrom. In some embodiments, an unbridged catalyst compound is represented by Formula (II). M is a group 4 metal. Each of R¹, R², R³, R⁴, R⁷, R⁸, R⁹, R¹⁰, R¹¹, R¹⁴, R¹⁵, R^{15′}, R¹⁶, R^{16′}, R¹⁷, R^{17′}, R¹⁸, R^{18′}, R¹⁹, R^{19′}, R²⁰, R^{20′}, R²¹, R^{21′}, R²², and R^{22′} is independently hydrogen, a substituted or unsubstituted hydrocarbyl, a substituted or unsubstituted heteroatom, or a substituted or unsubstituted heteroatom-containing group. Each X is independently a halide, a substituted or unsubstituted hydrocarbyl, a hydride, an amide, a substituted or unsubstituted alkoxide, a sulfide, a phosphide, or a combination thereof, or two of X are joined together to form a substituted or unsubstituted metallocycle ring, or two of X are joined to form a chelating ligand, a diene ligand, or an alkylidene.

### CROSS-REFERENCE TO RELATED APPLICATION

This application claims the benefit of U.S. Provisional Application No. 63/503,915, filed May 23, 2023 and entitled “Catalysts, Polyethylenes, Polymerizations Thereof, and Films Thereof”, the entirety of which is incorporated by reference herein.

### FIELD

The present disclosure relates to catalysts, catalyst systems, polyethylene polymers, polymerization processes for making such polyethylene polymers, and films made therefrom.

### BACKGROUND

Polyethylene (PE) polymers are often labeled according to their density, most commonly as low density PE (LDPE) (and their linear variant, linear LDPE or LLDPE) on the one hand, typically taken as those PEs having densities of 0.940 g/cm³ or below, and high density PE (HDPE) on the other hand, often taken as those PEs having density above 0.940 g/cm³. Increasingly, however, medium density PE (MDPE) is used as an additional classifier for PE densities, most typically referring to PE having density about 0.925 to about 0.940 g/cm³, and sometimes as much as 0.955 g/cm³ (overlapping the upper end of LDPE and lower end of HDPE density spaces). MDPEs and/or lower-density HDPEs can be used in applications such as lamitubes, blown breathable films, waterproof sheets, and pipe adhesives. For achieving high throughput rates during processing, it can be desirable for the polymers to have low melt rates at those shear rates typically encountered during extrusion and melt processing. Polymers with high melt indices (lower molecular weight) can often demonstrate the desired low melt viscosities in the extrusion shear rate regime. However, such high melt index polymers also exhibit low melt viscosities at lower shear rates (such as at zero shear viscosity) which would lead to poor bubble stability during processing. Metallocene-catalyzed variants of MDPEs and other PEs, while providing excellent mechanical properties, often still suffer from processing downsides and/or poor bubble stability. Such polymers can also exhibit lower melt strength, which can not only impact bubble stability (as just noted), but also lead to melt fracture (surface roughness or similar irregularities) in films produced at typical commercial extrusion rates.

Some polymers, particularly LDPE (typically produced using free radical polymerization), have a large degree of long chain branching (LCB), which can be beneficial for processing and bubble stability, as well as for mechanical properties like tear resistance, but LDPE is known for otherwise having poor mechanical properties relative to more linear and/or metallocene-catalyzed PE. Thus, various levels of LDPE have been blended with metallocene PEs (e.g., mLLDPEs and/or mMDPEs) to increase melt strength, to increase shear sensitivity, e.g., to increase flow at commercial shear rates in extruders, and to reduce the tendency to melt fracture. However, such blending generally has a negative impact on mechanical properties of films made from the polymers. Indeed, it has been a challenge to improve mLLDPE and/or mMDPE processability without sacrificing physical properties.

Overall, there is a need for new catalysts and MDPEs and/or HDPEs having a combination of desirable properties (such as density, melt index properties, long chain branching) while also providing commercially desirable polymerizations and extrusions of the MDPEs and/or HDPEs. For example, there is a need for new catalysts and MDPEs and/or HDPEs having low melt rates at those shear rates typically encountered during extrusion and melt processing and high melt viscosities at lower shear rates (such as at zero shear viscosity) for improved bubble stability during processing.

Some references of potential interest in this regard include: U.S. Pat. Nos. 6,479,424; 7,601,666; 8,829,115; 9,068,033; 10,633,471; 11,267,917; and 11,352,386; WO2021/257264; WO2022/015094; US2006/0122342; US2021/0332169; US2021/0388191; US2021/0395404; US2022/0185916; US2022/0315680; US2022/0064344; KR10-2022-0009900, KR10-2022-0009782; KR10-2021-0080974; KR10-2021-0038379; KR10-2020-0089599; KR10-2018-0063669; KR10-2007-0098276; and Foster, et al., Journal of Organometallic Chemistry, 571 (1998) 171.

### SUMMARY

The present disclosure relates to catalysts, catalyst systems, polyethylene polymers, polymerization processes for making such polyethylene polymers, and films made therefrom.

In some embodiments, a process for producing a polyethylene composition includes introducing, under polymerization conditions, ethylene and a C₃-C₄₀ alpha-olefin with a catalyst system in a reactor. The process includes forming a polyethylene copolymer. The catalyst system includes an unbridged catalyst compound represented by Formula (I):

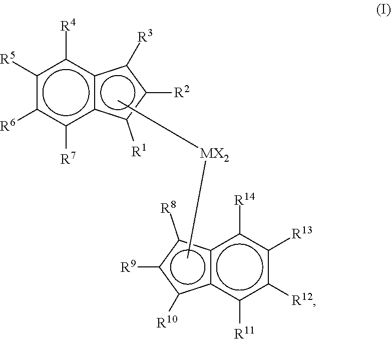

wherein:
M is a group 4 metal;
each of R¹, R², R³, R₄, R⁵, R⁶, R⁷, R⁸, R⁹, R¹⁰, R¹¹, R¹², R¹³ and R¹⁴ is independently hydrogen, substituted or unsubstituted hydrocarbyl, a substituted or unsubstituted heteroatom, or a substituted or unsubstituted heteroatom-containing group, or one or more of R¹ and R², R⁴ and R⁵, R⁵ and R⁶, R⁶ and R⁷, R⁹ and R¹⁰, R¹¹ and R¹², R¹² and R¹³, and R¹³ and R¹⁴ are joined to form a substituted or unsubstituted completely saturated ring or a substituted or unsubstituted aromatic ring, wherein if R¹² and R¹³ are joined to form a substituted or unsubstituted completely saturated ring, then R⁹ is not substituted or unsubstituted hydrocarbyl, wherein if R⁵ and R⁶ are joined to form a substituted or unsubstituted completely saturated ring, then R² is not substituted or unsubstituted hydrocarbyl;
wherein at least one of R⁴ and R⁵, R⁵ and R⁶, or R⁶ and R⁷ are joined to form a first substituted or unsubstituted completely saturated ring fused to the indenyl ring and at least one of R¹¹ and R¹², R¹² and R¹³, or R¹³ and R¹⁴ are joined to form a second substituted or unsubstituted completely saturated ring fused to the indenyl ring; and
each X is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene.

In some embodiments, a catalyst compound is an unbridged metallocene represented by Formula (II):

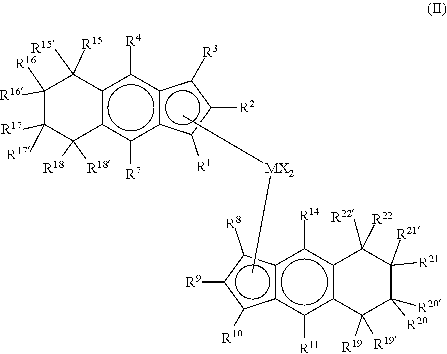

wherein:
M is a group 4 metal;
each of R¹, R², R³, R⁴, R⁷, R⁸, R⁹, R¹⁰, R¹¹, R¹⁴, R¹⁵, R^{15′}, R¹⁶, R^{16′}, R¹⁷, R^{17′}, R¹⁸, R^{18′}, R¹⁹, R^{19′}, R²⁰, R^{20′}, R²¹, R^{21′}, R²², and R^{22′} is independently hydrogen, a substituted or unsubstituted hydrocarbyl, a substituted or unsubstituted heteroatom, or a substituted or unsubstituted heteroatom-containing group; and
each X is independently a halide, a substituted or unsubstituted hydrocarbyl, a hydride, an amide, a substituted or unsubstituted alkoxide, a sulfide, a phosphide, or a combination thereof, or two of X are joined together to form a substituted or unsubstituted metallocycle ring, or two of X are joined to form a chelating ligand, a diene ligand, or an alkylidene.

In some embodiments, a polyethylene copolymer include about 95 wt % or greater ethylene units and a remainder balance of C₃-C₂₀ comonomer units. The polyethylene copolymer has a density of about 0.925 g/cm³ to about 0.955 g/cm³, a weight average molecular weight (Mw) of about 50,000 g/mol to about 300,000 g/mol, a number average molecular weight (Mn) of about 5,000 g/mol to about 50,000 g/mol, a z-average molecular weight (Mz) of about 300,000 g/mol to about 2,000,000 g/mol, a melt index of about 0.3 g/10 min to about 11 g/10 min, a melt index ratio of about 20 to about 200, a g′vis value of about 0.85 to about 0.97, and a composition distribution breadth index (CDBI) of about 40% to about 65%.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a graph illustrating overlay of complex viscosity of ethylene-hexene copolymers with Catalyst 19 in gas phase reactor, in accordance with various embodiments.

FIG. 2 is a graph illustrating overlay of extensional viscosity of ethylene-hexene copolymers with Catalyst 19 in gas phase reactor, in accordance with various embodiments.

FIG. 3 is a Van Gurp Palmen plot of ethylene-hexene copolymers from different catalysts in gas phase reactor, in accordance with various embodiments.

### DETAILED DESCRIPTION

Various embodiments, versions of the disclosed compounds, processes, and articles of manufacture, will now be described, including specific embodiments and definitions that are adopted herein. While the following detailed description gives specific embodiments, those skilled in the art should appreciate that these embodiments are exemplary only, and that embodiments of the present disclosure can be practiced in other ways. Any reference to embodiments may refer to one or more, but not necessarily all, of the compounds, processes, or articles of manufacture defined by the claims. The use of headings is for purposes of convenience only and does not limit the scope of the present disclosure.

The present disclosure relates to catalysts, catalyst systems, polyethylenes, polymerization processes for making such polyethylenes, and films made therefrom. Polyethylenes of the present disclosure can be medium density polyethylene (MDPE) or high density polyethylene (HDPE) formed using, for example, a metallocene catalyst, ethylene monomer, and a comonomer. Polyethylenes of the present disclosure can be characterized as having a unique balance of chemical, physical, and mechanical properties relative to conventional MDPE, conventional LLDPE, and other conventional polyethylene grades. For example, polyethylenes of the present disclosure exhibit a density that is traditionally associated with MDPE (or HDPE) while also having long chain branching and low melt index. The long chain branching and low melt index can be obtained even though (1) catalysts of the present disclosure can provide low comonomer incorporation and (2) polyethylenes of the present disclosure, in some embodiments, do not have broad orthogonal composition distribution (BOCD). BOCD refers to comonomer of a copolymer being incorporated predominantly in the high molecular weight chains of the copolymer composition formed during the polymerization. The lack of BOCD in polyethylene copolymers of the present disclosure can provide improved film properties even though the polyethylene copolymers (1) have good processability for film formation and (2) catalysts of the present disclosure provide high molecular weight (relatively lower melt index) polyethylenes.

Moreover, and as compared to traditional LLDPE and other conventional polyethylene grades, polyethylenes of the present disclosure can have a low melt index, higher viscosity at low shear rates (e.g., due to low comonomer incorporation in general and low comonomer content in high molecular weight portions of the polyethylene copolymer, in particular), and improved processability, for example, improved extrudability (e.g., due to long chain branching) while maintaining good bubble stability during fabrication processes. For example, catalysts and polymerizations of the present disclosure can provide polyethylenes having low melt rates at shear rates typically encountered during extrusion and melt processing as well as high melt viscosities at lower shear rates (such as at zero shear viscosity) for improved bubble stability during processing. Such advantages can be realized even though catalysts of the present disclosure provide high molecular weight polyethylene copolymers. For example, catalysts of the present disclosure provide improved molecular weight capability as compared to conventional bisindenyl zirconocenes. Such high molecular weight of polyethylene copolymers (in addition to lack of BOCD) can provide improved toughness properties of polyethylene copolymers, as compared to conventional MDPEs.

The polyethylenes described herein are polyethylene copolymers. As compared to conventional LLDPEs, polyethylene copolymers of the present disclosure have increased long chain branching (also referred to as “LCB”) in the copolymers providing reduced neck-in and increased draw stability. Polyethylene copolymers of the present disclosure can exhibit lower zero shear viscosity, leading to lower motor torque and lower melt pressures and melt temperatures during extrusion, providing increased output of the extruded polyethylene copolymer product. For example, a reduction in motor torque and melt pressure may be observed during cast film fabrication due to increased polymer LCB. The LCB can be evidenced through, for example, a high melt index ratio and/or particular rheology characteristics as shown through data obtained by small angle oscillatory shear (SAOS) experiments (for instance, ratio of η_{0.01}/η₁₀₀, the complex viscosity recorded at shear rates of 0.01 and 100 rad/s, respectively, as well as in Van Gurp Palmen plots of phase angle vs. complex modulus, which track viscosity responses in the polymer to applied shear).

### Definitions

As used herein, an “olefin,” alternatively referred to as “alkene,” is a linear, branched, or cyclic compound of carbon and hydrogen having at least one double bond. For purposes of this specification and the claims appended thereto, when a polymer or copolymer is referred to as “comprising” an olefin, the olefin present in such polymer or copolymer is the polymerized form of the olefin. For example, when a copolymer is described as having an “ethylene” content of about 35 wt % to about 55 wt %, it is understood that the mer unit in the copolymer is derived from ethylene in the polymerization reaction and the derived units are present at about 35 wt % to about 55 wt %, based upon the weight of the copolymer.

As used herein, the terms “polyethylene polymer,” “polyethylene copolymer,” “polyethylene,” “ethylene polymer,” “ethylene copolymer,” and “ethylene based polymer” mean a polymer or copolymer comprising at least 50 mol % ethylene units, or at least 70 mol % ethylene units, or at least 80 mol % ethylene units, or at least 90 mol % ethylene units, or at least 95 mol % ethylene units or 100 mol % ethylene units (in the case of a homopolymer).

As used herein, a “polymer” may refer to homopolymers, copolymers, interpolymers, terpolymers, etc. A “polymer” has two or more of the same or different monomer units. A “homopolymer” is a polymer having monomer units that are the same. A “copolymer” is a polymer having two or more monomer units that are different from each other. A “terpolymer” is a polymer having three monomer units that are different from each other. The term “different” as used to refer to monomer units indicates that the monomer units differ from each other by at least one atom or are different isomerically. Accordingly, the definition of copolymer, as used herein, includes terpolymers and the like. Likewise, the definition of polymer, as used herein, includes copolymers and the like.

As used herein, an ethylene polymer having a density of greater than 0.860 to less than 0.910 g/cm³ may be referred to as an ethylene plastomer or plastomer; an ethylene polymer having a density of 0.910 to less than 0.925 g/cm³ may be referred to as a “linear low density polyethylene” (LLDPE) when substantially linear (having minor or no long chain branching) as is typically the case for Ziegler-Nata or metallocene-catalyzed PE or branched low density polyethylene (LDPE) when significantly branched (having a high degree of long chain branching), as is often the case with free-radical polymerized PE; 0.925 to 0.940 g/cm³ may be referred to as a “medium density polyethylene” (MDPE); and an ethylene polymer having a density of greater than 0.940 g/cm³ may be referred to as a “high density polyethylene” (HDPE). Density is determined according to ASTM D792. Specimens are prepared according to ASTM D4703—Annex 1 Procedure C followed by conditioning according to ASTM D618—Procedure A prior to testing.

As used herein, and unless otherwise specified, the term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated or unsaturated), including mixtures of hydrocarbon compounds having different values of n.

As used herein, a composition or film “free of” a component refers to a composition/film substantially devoid of the component, or comprising the component in an amount of less than 0.01 wt %, by weight of the total composition.

As used herein, the term “polymerization conditions” refers to conditions conducive to the reaction of one or more olefin monomers when contacted with an activated olefin polymerization catalyst to produce a polyolefin polymer, including a skilled artisan's selection of temperature, pressure, reactant concentrations, optional solvent/diluents, reactant mixing/addition parameters, and other conditions within at least one polymerization reactor.

For the purposes of the present disclosure, the numbering scheme for the Periodic Table Groups is used as described in Chemical and Engineering News, 63(5), pg. 27 (1985).

The following abbreviations may be used herein: Me is methyl, Et is ethyl, Ph is phenyl, PDI is polydispersity index, MAO is methylalumoxane, SMAO is supported methylalumoxane, NMR is nuclear magnetic resonance, ppm is part per million, THF is tetrahydrofuran.

As used herein, olefin polymerization catalyst(s) refer to any catalyst, such as an organometallic complex or compound that is capable of coordination polymerization addition where successive monomers are added in a monomer chain at the organometallic active center.

The terms “substituent,” “radical,” “group,” and “moiety” may be used interchangeably.

The term “alpha-olefin” refers to an olefin having a terminal carbon-to-carbon double bond in the structure thereof ((R″R″′)—C═CH₂, where R″ and R′″ can be independently hydrogen or any hydrocarbyl group; such as R″ is hydrogen and R″′ is an alkyl group). A “linear alpha-olefin”is an alpha-olefin defined in this paragraph wherein R″ is hydrogen, and R″ is hydrogen or a linear alkyl group.

For the purposes of the present disclosure, ethylene shall be considered an alpha-olefin.

As used herein, and unless otherwise specified, the term “Cₙ” means hydrocarbon(s) having n carbon atom(s) per molecule, wherein n is a positive integer. The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and or unsaturated), including mixtures of hydrocarbon compounds having different values of n. Likewise, a “Cₘ-C_{y}” group or compound refers to a group or compound including carbon atoms at a total number thereof from m to y. Thus, a C₁-C₅₀ alkyl group refers to an alkyl group including carbon atoms at a total number thereof of about 1 to about 50.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halide (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halide, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted aromatic,” means an aromatic group having 1 or more hydrogen groups replaced by a hydrocarbyl, substituted hydrocarbyl, heteroatom or heteroatom containing group.

The terms “hydrocarbyl radical,” “hydrocarbyl group,” or “hydrocarbyl” may be used interchangeably and are defined to mean a group including hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and aryl groups, such as phenyl, benzyl, naphthyl.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl. The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxyl.

The term “alkenyl” means a straight-chain, branched-chain, or cyclic hydrocarbon radical having one or more double bonds. These alkenyl radicals may be optionally substituted. Examples of suitable alkenyl radicals can include ethenyl, propenyl, allyl, 1,4-butadienyl, cyclopropenyl, cyclobutenyl, cyclopentenyl, cyclohexenyl, cycloctenyl, including their substituted analogues.

The terms “alkyl radical,” “alkyl group,” and “alkyl” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, including their substituted analogues. Some examples of alkyl may include 1-methylethyl, 1-methylpropyl, 1-methylbutyl, 1-ethylbutyl, 1,3-dimethylbutyl, 1-methyl-1-ethylbutyl, 1,1-diethylbutyl, 1-propylpentyl, 1-phenylethyl, i-propyl, 2-butyl, sec-pentyl, sec-hexyl, and the like.

The term “aryl” or “aryl group” means an aromatic ring and the substituted variants thereof, such as phenyl, 2-methyl-phenyl, xylyl, 4-bromo-xylyl. Likewise, “heteroaryl” means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

Where isomers of a named alkyl, alkenyl, alkoxide, or aryl group exist (e.g., n-butyl, iso-butyl, sec-butyl, and tert-butyl), reference to an alkyl, alkenyl, alkoxide, or aryl group without specifying a particular isomer (e.g., butyl) expressly discloses all isomers (e.g., n-butyl, iso-butyl, sec-butyl, and tert-butyl).

The term “ring atom” means an atom that is part of a cyclic ring structure. By this definition, a benzyl group has six ring atoms and tetrahydrofuran has five ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol.

The terms “catalyst compound”, “catalyst complex”, “transition metal complex”, “transition metal compound”, “precatalyst compound”, and “precatalyst complex” are used interchangeably.

A “catalyst system” is a combination of at least one catalyst compound, at least one activator, an optional coactivator, and an optional support material. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The catalyst compound may be neutral as in a precatalyst, or a charged species with a counter ion as in an activated catalyst system. For the purposes of the present disclosure and the claims thereto, when catalyst systems are described as including neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein are intended to embrace both neutral and ionic forms of the catalyst compounds and activators.

An “anionic ligand” is a negatively charged ligand which donates one or more pairs of electrons to a metal ion. A “Lewis base” or “neutral donor ligand” is a neutrally charged ligand which donates one or more pairs of electrons to a metal ion. Examples of Lewis bases include ethylether, trimethylamine, pyridine, tetrahydrofuran, dimethylsulfide, and triphenylphosphine. The term “heterocyclic Lewis base” refers to Lewis bases that are also heterocycles. Examples of heteroyclic Lewis bases include pyridine, imidazole, thiazole, and furan.

A scavenger is a compound that can be added to facilitate polymerization by scavenging impurities. Some scavengers may also act as activators and may be referred to as coactivators. A coactivator, that is not a scavenger, may also be used in conjunction with an activator in order to form an active catalyst. In at least one embodiment, a coactivator can be pre-mixed with the transition metal compound to form an alkylated transition metal compound.

The term “continuous” means a system that operates without interruption or cessation for an extended period of time. For example a continuous process to produce a polymer would be one where the reactants are continually introduced into one or more reactors and polymer product is continually withdrawn.

A solution polymerization means a polymerization process in which the polymer is dissolved in a liquid polymerization medium, such as an inert diluent or monomer(s) or their blends. A solution polymerization can be homogeneous. A homogeneous polymerization is one where the polymer product is dissolved in the polymerization medium. Suitable systems may be not turbid as described in J. Vladimir Oliveira, C. Dariva and J. C. Pinto, Ind. Eng. Chem. Res., 2000, Vol. 29, p. 4627.

A bulk polymerization means a polymerization process in which the monomers and or comonomers being polymerized are used as a solvent or diluent using little or no inert solvent as a solvent or diluent. A small fraction of inert solvent/diluent might be used as a carrier for catalyst and scavenger. A bulk polymerization system contains less than 25 wt % of inert solvent or diluent, such as less than 10 wt %, such as less than 1 wt %, such as 0 wt %.

The term “single catalyst compound” refers to a catalyst compound corresponding to a single structural formula, although such a catalyst compound may comprise and be used as a mixture of isomers, e.g., stereoisomers.

A catalyst system that utilizes a single catalyst compound means a catalyst system that is prepared using only a single catalyst compound in the preparation of the catalyst system. Thus, such a catalyst system is distinguished from, for example, “dual” catalyst systems, which are prepared using two catalyst compounds having different structural formulas, e.g., the connectivity between the atoms, the number of atoms, and/or the type of atoms in the two catalyst compounds is different. Thus, one catalyst compound is considered different from another if it differs by at least one atom, either by number, type, or connection. For example bisindenyl zirconium dichloride is different from (indenyl)(2-methylindenyl) zirconium dichloride which is different from (indenyl)(2-methylindenyl) hafnium dichloride. Unless otherwise noted, catalyst compounds that differ only in that they are stereoisomers of each other are not considered to be different catalyst compounds. For example, rac-dimethylsilylbis(2-methyl 4-phenyl)hafnium dimethyl and meso-dimethylsilylbis(2-methyl 4-phenyl)hafnium dimethyl are considered to be not different.

The terms “cocatalyst” and “activator” are used herein interchangeably and are defined to be any compound which can activate any one of the catalyst compounds described above by converting the neutral catalyst compound to a catalytically active catalyst compound cation.

In an extrusion process, “viscosity” is a measure of resistance to shearing flow. Shearing is the motion of a fluid, layer-by-layer, like a deck of cards. When polymers flow through straight tubes or channels, the polymers are sheared and resistance is expressed in terms of viscosity.

“Extensional” or “elongational viscosity” is the resistance to stretching. In fiber spinning, film blowing and other processes where molten polymers are stretched, the elongational viscosity plays a role. For example, for certain liquids, the resistance to stretching can be three times larger than in shearing. For some polymeric liquids, the elongational viscosity can increase (tension stiffening) with the rate, although the shear viscosity decreased.

The term “melt index” (“MI”) is the number of grams extruded in 10 minutes under the action of a standard load (2.16 kg) and is an inverse measure of viscosity. A high MI implies low viscosity and a low MI implies high viscosity. In addition, polymers can have shear thinning behavior, which means that their resistance to flow decreases as the shear rate increases. This is due to, e.g., molecular alignments in the direction of flow and disentanglements. As provided herein, MI (I₂) is determined according to ASTM D1238-E (190° C./2.16 kg), also sometimes referred to as I₂ or I_{2.16}.

The term “high load melt index” (“HLMI”), is the number of grams extruded in 10 minutes under the action of a standard load (21.6 kg) and is an inverse measure of viscosity. As provided herein, HLMI (121) is determined according to ASTM D1238 (190° C./21.6 kg) and is also sometimes referred to as I₂₁ or I_{21.6}.

The “melt index ratio” (“MIR”) provides an indication of the amount of shear thinning behavior of the polymer and is a parameter that can be correlated to the overall polymer mixture molecular weight distribution data obtained separately by using Gel Permeation Chromatography (“GPC”) and possibly in combination with another polymer analysis including TREF. MIR is the ratio of I₂₁/I₂ (also referred to as HLMI/MI).

The term “melt strength” is a measure of the extensional viscosity and is representative of the maximum tension that can be applied to the melt without breaking. Extensional viscosity is the polyethylene's ability to resist thinning at high draw rates and high draw ratios. In melt processing of polyolefins, the melt strength is defined by characteristics that can be quantified in process-related terms and in rheological terms. In extrusion blow molding and melt phase thermoforming, a branched polyolefin of the appropriate molecular weight can support the weight of the fully melted sheet or extruded portion prior to the forming stage. This behavior is sometimes referred to as sag resistance.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, “in a range” or “within a range” includes every point or individual value between its end points even though not explicitly recited and includes the end points themselves. Thus, every point or individual value may serve as its own lower or upper limit combined with any other point or individual value or any other lower or upper limit, to recite a range not explicitly recited.

### Catalyst Compounds

A catalyst compound of the present disclosure can be unsupported or supported onto a support material.

In some embodiments, a catalyst compound is an unbridged metallocene represented by Formula (I):

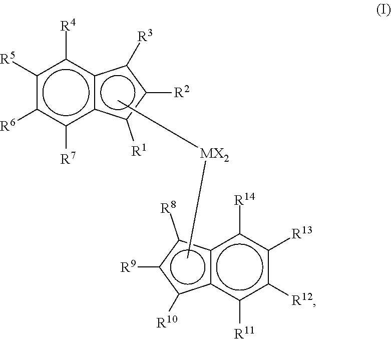

wherein:
M is a group 4 metal, such as titanium (Ti), zirconium (Zr), or hafnium (Hf);
each of R¹, R², R³, R⁴, R⁵, R⁶, R⁷, R⁸, R⁹, R¹⁰, R¹¹, R¹², R¹³ and R¹⁴ is independently hydrogen, substituted or unsubstituted hydrocarbyl, a substituted or unsubstituted heteroatom, or a substituted or unsubstituted heteroatom-containing group, or one or more of R¹ and R², R⁴ and R⁵, R⁵ and R⁶, R⁶ and R⁷, R⁹ and R¹⁰, R¹¹ and R¹², R¹² and R¹³, and R¹³ and R¹⁴ are joined to form a substituted or unsubstituted completely saturated ring or a substituted or unsubstituted aromatic ring, wherein if R¹² and R¹³ are joined to form a substituted or unsubstituted completely saturated ring, then R⁹ is not substituted or unsubstituted hydrocarbyl, wherein if R⁵ and R⁶ are joined to form a substituted or unsubstituted completely saturated ring, then R² is not substituted or unsubstituted hydrocarbyl;
wherein at least one of (1) R⁴ and R⁵, (2) R⁵ and R⁶, or (3) R⁶ and R⁷ are joined to form a first substituted or unsubstituted completely saturated ring fused to the indenyl ring shown in Formula (I), and at least one of (1) R¹¹ and R¹², (2) R¹² and R¹³, or (3) R¹³ and R¹⁴ are joined to form a second substituted or unsubstituted completely saturated ring fused to the indenyl ring shown in Formula (I); and
each X is independently a halide, a substituted or unsubstituted hydrocarbyl, a hydride, an amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene.

In some embodiments, each of R⁴, R⁵, R⁶, R⁷, R¹¹, R¹², R¹³ and R¹⁴ of Formula (I) is independently hydrogen or C₁-C₁₀ alkyl (such as methyl, ethyl, propyl, butyl, pentyl, hexyl, heptyl, octyl, nonyl, or decyl), wherein at least one of (1) R⁴ and R⁵, (2) R⁵ and R⁶, or (3) R⁶ and R⁷ are joined to form a first substituted or unsubstituted completely saturated ring fused to the indenyl ring shown in Formula (I), and at least one of (1) R¹¹ and R¹², (2) R¹² and R¹³, or (3) R¹³ and R¹⁴ are joined to form a second substituted or unsubstituted completely saturated ring fused to the indenyl ring shown in Formula (I).

In some embodiments, at least one of (1) R⁴ and R⁵, (2) R⁵ and R⁶, or (3) R⁶ and R⁷ are joined to form a first substituted or unsubstituted completely saturated ring fused to the indenyl ring shown in Formula (I). In some embodiments, R⁴ and R⁵ are joined to form a substituted or unsubstituted saturated C₄ ring, a substituted or unsubstituted saturated C₅ ring, a substituted or unsubstituted saturated C₆ ring, or a substituted or unsubstituted saturated C₇ ring, where the C₄ ring, C₅ ring, C₆ ring, or C₇ ring is fused to the indenyl ring shown in Formula (I). In some embodiments, R⁵ and R⁶ are joined to form a substituted or unsubstituted saturated C₄ ring, a substituted or unsubstituted saturated C₅ ring, a substituted or unsubstituted saturated C₆ ring, or a substituted or unsubstituted saturated C₇ ring, where the C₄ ring, C₅ ring, C₆ ring, or C₇ ring is fused to the indenyl ring shown in Formula (I). In some embodiments, R⁶ and R⁷ are joined to form a substituted or unsubstituted saturated C₄ ring, a substituted or unsubstituted saturated C₅ ring, a substituted or unsubstituted saturated C₆ ring, or a substituted or unsubstituted saturated C₇ ring, where the C₄ ring, C₅ ring, C₆ ring, or C₇ ring is fused to the indenyl ring shown in Formula (I).

In some embodiments, at least one of (1) R¹¹ and R¹², (2) R¹² and R¹³, or (3) R¹³ and R¹⁴ are joined to form a first substituted or unsubstituted completely saturated ring fused to the indenyl ring shown in Formula (I). In some embodiments, R¹¹ and R¹² are joined to form a substituted or unsubstituted saturated C₄ ring, a substituted or unsubstituted saturated C₅ ring, a substituted or unsubstituted saturated C₆ ring, or a substituted or unsubstituted saturated C₇ ring, where the C₄ ring, C₅ ring, C₆ ring, or C₇ ring is fused to the indenyl ring shown in Formula (I). In some embodiments, R¹² and R¹³ are joined to form a substituted or unsubstituted saturated C₄ ring, a substituted or unsubstituted saturated C₅ ring, a substituted or unsubstituted saturated C₆ ring, or a substituted or unsubstituted saturated C₇ ring, where the C₄ ring, C₅ ring, C₆ ring, or C₇ ring is fused to the indenyl ring shown in Formula (I). In some embodiments, R¹³ and R¹⁴ are joined to form a substituted or unsubstituted saturated C₄ ring, a substituted or unsubstituted saturated C₅ ring, a substituted or unsubstituted saturated C₆ ring, or a substituted or unsubstituted saturated C₇ ring, where the C₄ ring, C₅ ring, C₆ ring, or C₇ ring is fused to the indenyl ring shown in Formula (I).

In some embodiments, each of R¹, R², R³, R⁸, R⁹, and R¹⁰ of Formula (I) is independently hydrogen or C₁-C₁₀ alkyl (such as methyl, ethyl, propyl, butyl, pentyl, hexyl, heptyl, octyl, nonyl, or decyl). In some embodiments, each of R¹, R², R³, R⁸, R⁹, and R¹⁰ is independently hydrogen, methyl, ethyl, or propyl. In some embodiments, each of R¹, R², R³, R⁸, R⁹, and R¹⁰ is hydrogen. In some embodiments, each of R¹, R², R³, R⁸, R⁹, and R¹⁰ is methyl. In some embodiments, at least one of R³ and R¹⁰ is C₁-C₁₀ alkyl. In some embodiments, each of R³ and R¹⁰ is independently C₁-C₁₀ alkyl. In some embodiments, each of R³ and R¹⁰ are C₁-C₁₀ alkyl (such as methyl) and R¹, R², R⁴, R⁵, R⁶, R⁷, R⁸, R⁹, R¹¹, R¹², R¹³ and R¹⁴ are hydrogen.

In some embodiments, one or more of R¹, R², R³, R₄, R⁵, R⁶, R⁷, R⁸, R⁹, R¹⁰, R¹¹, R¹², R¹³ and R¹⁴ of Formula (I) is independently hydrogen, hydrocarbyl, silylcarbyl, alkoxyl, halide, or siloxyl.

In some embodiments of Formula (I), M is a group 4 metal, such as titanium (Ti), zirconium (Zr), or hafnium (Hf), such as Zr or Hf. In some embodiments, each X is independently a halide, such as chloro. In yet other embodiments, each X is independently a C₁-C₄ alkyl, such as methyl. In some embodiments, each X is independently selected from substituted or unsubstituted hydrocarbyl, a heteroatom or substituted or unsubstituted heteroatom-containing group, such as methyl, benzyl, trimethylsilyl, methyl(trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido.

In some embodiments of Formula (I), (1) M is Zr or Hf, (2) X is C₁-C₄ alkyl, (3) R¹, R², R³, R⁴, R⁵, R⁶, and R⁷ is independently hydrogen or substituted or unsubstituted C₁-C₁₀ alkyl, (4) R⁸, R⁹, R¹⁰, R¹¹, R¹², R¹³ and R¹⁴ is independently hydrogen or substituted or unsubstituted C₁-C₁₀ alkyl, (5) at least one of R⁴ and R⁵, R⁵ and R⁶, or R⁶ and R⁷ are joined to form a substituted completely saturated ring fused to the indenyl ring shown in Formula (I), and (6) R¹¹ and R¹², R¹² and R¹³, or R¹³ and R¹⁴ are joined to form a substituted completely saturated ring fused to the indenyl ring shown in Formula (I).

In some embodiments, a catalyst compound is an unbridged metallocene represented by Formula (II):

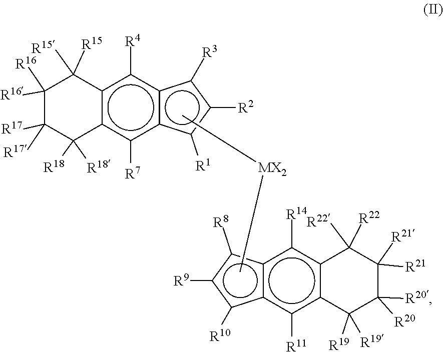

wherein:
M is a group 4 metal, such as titanium (Ti), zirconium (Zr), or hafnium (Hf);
each of R¹, R², R³, R⁴, R⁷, R⁸, R⁹, R¹⁰, R¹¹, R¹⁴, R¹⁵, R^{15′}, R¹⁶, R^{16′}, R¹⁷, R^{17′}, R¹⁸, R^{18′}, R¹⁹, R^{19′}, R²⁰, R^{20′}, R²¹, R^{21′}, R²², and R^{22′} is independently hydrogen, a substituted or unsubstituted hydrocarbyl, a substituted or unsubstituted heteroatom, or a substituted or unsubstituted heteroatom-containing group; and
each X is independently a halide, a substituted or unsubstituted hydrocarbyl, a hydride, an amide, substituted or unsubstituted alkoxide, a sulfide, a phosphide, or a combination thereof, or two of
X are joined together to form a substituted or unsubstituted metallocycle ring, or two of X are joined to form a chelating ligand, a diene ligand, or an alkylidene.

In some embodiments, each of R⁴, R⁷, R¹¹, R¹⁴, R¹⁵, R^{15′}, R¹⁶, R^{16′}, R¹⁷, R^{17′}, R¹⁸, R^{18′}, R¹⁹, R^{19′}, R²⁰, R^{20′}, R²¹, R^{21′}, R²², and R^{22′} of Formula (II) is independently hydrogen or C₁-C₁₀ alkyl (such as methyl, ethyl, propyl, butyl, pentyl, hexyl, heptyl, octyl, nonyl, or decyl). In some embodiments, each of R¹⁵, R^{15′}, R¹⁸, R^{18′}, R¹⁹, R^{19′}, R²², and R^{22′} is independently hydrogen, methyl, ethyl, or propyl. In some embodiments, each of R¹⁵, R^{15′}, R¹⁸, R^{18′}, R¹⁹, R^{19′}, R²², and R^{22′} is hydrogen. In some embodiments, each of R¹⁵, R^{15′}, R¹⁸, R^{18′}, R¹⁹, R^{19′}, R²², and R^{22′} is C₁-C₁₀ alkyl (such as methyl). In some embodiments, each of R⁴, R⁷, R¹¹, R¹⁴, R¹⁶, R^{16′}, R¹⁷, R^{17′}, R²⁰, R^{20′}, R²¹, and R^{21′} is hydrogen.

In some embodiments, each of R¹, R², R³, R⁸, R⁹, and R¹⁰ of Formula (II) is independently hydrogen or C₁-C₁₀ alkyl (such as methyl, ethyl, propyl, butyl, pentyl, hexyl, heptyl, octyl, nonyl, or decyl). In some embodiments, each of R¹, R², R³, R⁸, R⁹, and R¹⁰ is independently hydrogen, methyl, ethyl, or propyl. In some embodiments, each of R¹, R², R³, R⁸, R⁹, and R¹⁰ is hydrogen. In some embodiments, each of R¹, R², R³, R⁸, R⁹, and R¹⁰ is methyl. In some embodiments, at least one of R³ and R¹⁰ is C₁-C₁₀ alkyl. In some embodiments, each of R³ and R¹⁰ is independently C₁-C₁₀ alkyl. In some embodiments, R³ and R¹⁰ are C₁-C₁₀ alkyl (such as methyl), and R¹, R², R⁸, and R⁹ are hydrogen.

In some embodiments of Formula (II), M is a group 4 metal, such as titanium (Ti), zirconium (Zr), or hafnium (Hf), such as Zr or Hf. In some embodiments, each X is independently a halide, such as chloro. In yet other embodiments, each X is independently a C₁-C₄ alkyl, such as methyl. In some embodiments, each X is independently selected from substituted or unsubstituted hydrocarbyl, a heteroatom or substituted or unsubstituted heteroatom-containing group, such as methyl, benzyl, trimethylsilyl, methyl(trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido.

In some embodiments of Formula (II), (1) M is Zr or Hf, (2) X is C₁-C₄ alkyl, (3) R¹, R², R³, R₄, R⁷, R¹⁵, R^{15′}, R¹⁶, R^{16′}, R¹⁷, R^{17′}, R¹⁸, and R^{18′} is independently hydrogen or substituted or unsubstituted C₁-C₁₀ alkyl, and (4) R⁸, R⁹, R¹⁰, R¹¹, R¹⁴, R¹⁹, R^{19′}, R²⁰, R^{20′}, R²¹, R^{21′}, R²², and R^{22′} is independently hydrogen or substituted or unsubstituted C₁-C₁₀ alkyl.

In some embodiments of Formula (II), the catalyst is:

| | | | |
|---|---|---|---|
| 1 | 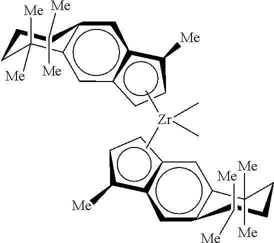 | 2 | 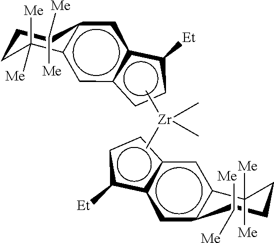 |
| 3 | 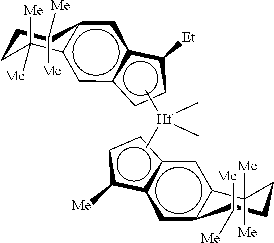 | 4 | 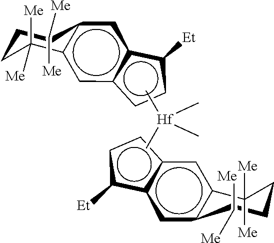 |
| 5 | 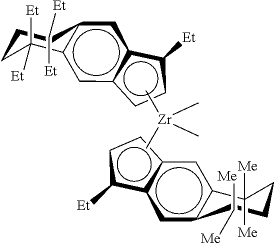 | 6 | 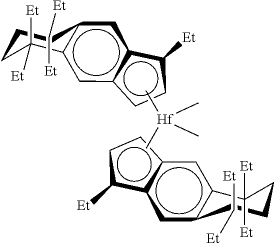 |
| 7 | 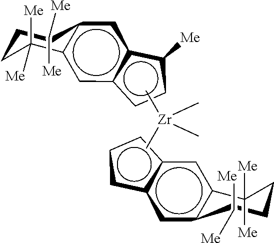 | 8 | 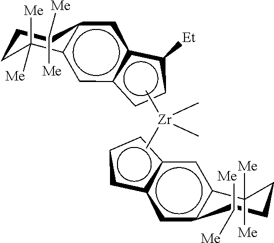 |
| 9 | 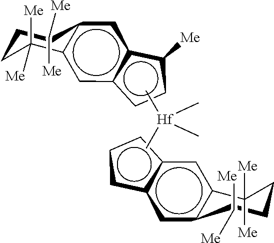 | 10 | 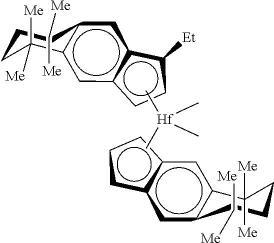 |
| 11 | 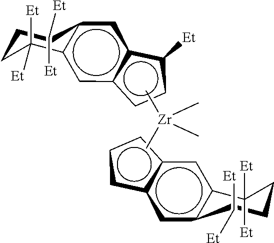 | 12 | 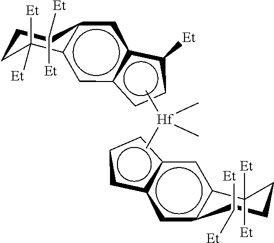 |
| 13 | 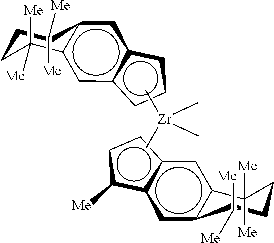 | 14 | 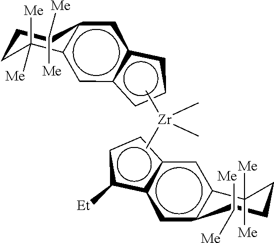 |
| 15 | 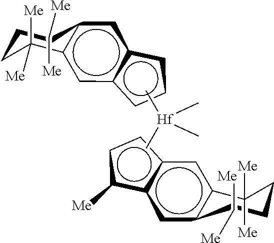 | 16 | 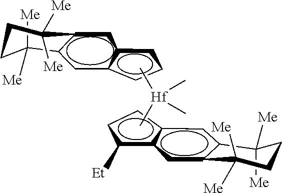 |
| 17 | 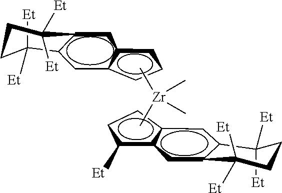 | 18 | 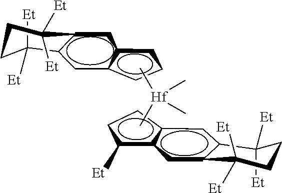 |
| 19 | 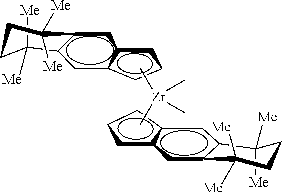 | 20 | 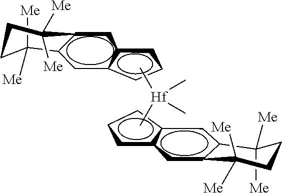 |
| 21 | 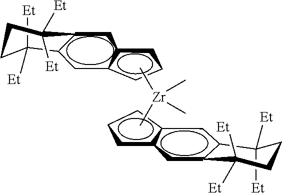 | 22 | 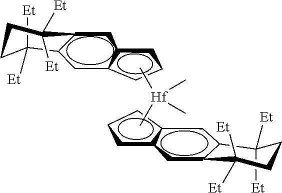 |

### Polymerization Processes

A polymerization process can include a gas phase polymerization reaction, and in particular a fluidized bed gas phase polymerization reaction. Generally, in a fluidized gas bed process used for producing polymers, a gaseous stream containing one or more monomers is continuously cycled through a fluidized bed in the presence of a catalyst under reactive conditions. In some embodiments, the reaction medium includes condensing agents, which are typically non-coordinating inert liquids that are converted to gas in the polymerization processes, such as isopentane, isohexane, or isobutane. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are incorporated herein by reference.) The gas-phase polymerization may be carried out in any suitable reactor system, e.g., a stirred- or paddle-type reactor system. See U.S. Pat. Nos. 7,915,357; 8,129,484; 7,202,313; 6,833,417; 6,841,630; 6,989,344; 7,504,463; 7,563,851; and 8,101,691 for discussion of suitable gas phase fluidized bed polymerization systems, which are incorporated herein by reference.

In such polymerization processes, a gas-phase, fluidized-bed process is conducted by passing a stream containing ethylene and an olefin comonomer continuously through a fluidized-bed reactor under reaction conditions and in the presence of a catalyst composition at a velocity sufficient to maintain a bed of solid particles in a suspended state. A stream (which may be called a “cycle gas” stream) containing unreacted ethylene and olefin comonomer is continuously withdrawn from the reactor, compressed, cooled, optionally partially or fully condensed, and recycled back to the reactor. Prepared polyethylene copolymer is withdrawn from the reactor and replacement ethylene and olefin comonomer are added to the recycle stream. In some embodiments, gas inert to the catalyst composition and reactants is present in the gas stream.

The cycle gas can include induced condensing agents (ICA). An ICA is one or more non-reactive alkanes that are condensable in the polymerization process for removing the heat of reaction. In some embodiments, the non-reactive alkanes are selected from C₁-C₆ alkanes, e.g., one or more of propane, butane, isobutane, pentane, isopentane, hexane, as well as isomers thereof and derivatives thereof. In some instances, mixtures of two or more such ICAs may be particularly useful (e.g., propane and pentane, propane and butane, butane and pentane, etc.).

The reactor pressure during polymerization may be about 100 psig (680 kPag)-about 500 psig (3448 kPag), such as about 200 psig (1379 kPag)-about 400 psig (2759 kPag), such as about 250 psig (1724 kPag)-about 350 psig (2414 kPag). In some embodiments, the reactor is operated at a temperature of about 60° C. to about 120° C., such as about 60° C. to about 115° C., such as about 70° C. to about 110° C., such as about 70° C. to about 95° C., such as about 80° C. to about 90° C. A ratio of hydrogen gas to ethylene can be about 10 to about 30 ppm/mol %, such as about 15 to about 25 ppm/mol %, such as about 16 to about 20 ppm/mol %.

The mole percent of ethylene (based on total monomers) may be about 25-about 90 mole percent, such as about 50-about 90 mole percent, or about 70-about 85 mole percent, and the ethylene partial pressure (in the reactor) can be about 75 psia (517 kPa)-about 300 psia (2069 kPa), or about 100 psia-about 275 psia (689-1894 kPa), or about 150 psia-about 265 psia (1034-1826 kPa), or about 180 psia-about 200 psia. Ethylene concentration in the reactor can also range from about 35 mol %-about 95 mol %, such as within the range from a low of 35, 40, 45, 50, or 55 mol % to a high of 70, 75, 80, 85, 90, or 95 mol % and further where ethylene mol % is measured on the basis of total moles of gas in the reactor (including, if present, ethylene and/or comonomer gases as well as inert gases such as one or more of nitrogen, isopentane or other ICA(s), etc.); as with vol-ppm hydrogen, this measurement may for convenience be taken in the cycle gas outlet rather than in the reactor itself. Comonomer concentration can be about 0.2-about 1 mol %, such as from a low of 0.2, 0.3, 0.4 or 0.5 mol % to a high of 0.65, 0.70, 0.75, 0.80, 0.85, 0.90, 0.95, or 1.0 mol %.

### Activators

The terms “cocatalyst” and “activator” are used herein interchangeably.

The catalyst systems described herein may include catalyst compound(s) as described above and an activator such as alumoxane or a non-coordinating anion and may be formed by combining the catalyst compounds described herein with activators in any manner known from the literature including combining them with supports, such as silica. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, may include alumoxanes, aluminum alkyls, ionizing activators, which may be neutral or ionic, and conventional-type cocatalysts. Suitable activators may include alumoxane compounds, modified alumoxane compounds, and ionizing anion precursor compounds that abstract a reactive, σ-bound, metal ligand making the metal compound cationic and providing a charge-balancing non-coordinating or weakly coordinating anion, e.g., a non-coordinating anion.

In at least one embodiment, the catalyst system includes an activator, a catalyst compound as described herein, and optionally a support.

### Alumoxane Activators

Alumoxane activators are utilized as activators in the catalyst systems described herein. Alumoxanes are generally oligomeric compounds containing —Al(R^{a′″})—O— sub-units, where R^{a′″} is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, such as when the abstractable ligand is an alkyl, halide, alkoxide or amide. Mixtures of different alumoxanes and modified alumoxanes may also be used. It may be suitable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, as described in U.S. Pat. No. 5,041,584, which is incorporated by reference herein). Another useful alumoxane is solid polymethylaluminoxane as described in U.S. Pat. Nos. 9,340,630, 8,404,880, and 8,975,209, which are incorporated by reference herein.

When the activator is an alumoxane (modified or unmodified), and in at least one embodiment, an amount of activator at up to a 5,000-fold molar excess Al/M over the catalyst compound (per metal catalytic site) may be used. The minimum activator-to-catalyst-compound may be a 1:1 molar ratio. Alternate ranges may include about 1:1 to about 500:1, alternately about 1:1 to about 200:1, alternately about 1:1 to about 100:1, or alternately about 1:1 to about 50:1.

In an alternate embodiment, little or no alumoxane is used in the polymerization processes described herein. For example, alumoxane can be present at zero mol %, alternately the alumoxane can be present at a molar ratio of aluminum to catalyst compound transition metal less than 500:1, such as less than 300:1, such as less than 100:1, such as less than 1:1.

### Ionizing/Non-Coordinating Anion Activators

The term “non-coordinating anion” (NCA) means an anion which either does not coordinate to a cation or which is only weakly coordinated to a cation thereby remaining sufficiently labile to be displaced by a Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization. Suitable ionizing activators may include an NCA, such as a compatible NCA.

It is within the scope of the present disclosure to use an ionizing activator, neutral or ionic. It is also within the scope of the present disclosure to use neutral or ionic activators alone or in combination with alumoxane or modified alumoxane activators.

For descriptions of some suitable activators and activator combinations, as well as relative amounts of activators and catalyst compounds, and optional chain transfer agents for use in conjunction with these catalyst compounds, please see U.S. Pat. Nos. 8,658,556 and 6,211,105, incorporated by reference herein; as well as U.S. Patent Publication 2021/0179650, and in particular Paragraphs [0084]-[0135] of WIPO Patent Publication No. WO2021/257264, which description is incorporated by reference herein (including the various descriptions that are incorporated by reference therein, such as WO2004/026921 page 72, paragraph [00119] to page 81, paragraph [00151] and WO2004/046214 page 72, paragraph [00177] to page 74, paragraph [00178]).

Furthermore, a catalyst system of the present disclosure may include a metal hydrocarbenyl chain transfer agent represented by the formula:

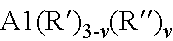

where each R′ can be independently a C₁-C₃₀ hydrocarbyl group, and or each R″, can be independently a C₄-C₂₀ hydrocarbenyl group having an end-vinyl group; and v can be from 0.1 to 3.

### Support Materials

In embodiments herein, the catalyst system may include an inert support material. The support material can be a porous support material, for example, talc, and inorganic oxides. Other support materials include zeolites, clays, organoclays, or another organic or inorganic support material, or mixtures thereof.

The support material can be an inorganic oxide. The inorganic oxide can be in a finely divided form. Suitable inorganic oxide materials for use in catalyst systems herein may include groups 2, 4, 13, and 14 metal oxides, such as silica, alumina, and mixtures thereof. Other inorganic oxides that may be employed either alone or in combination with the silica, or alumina can be magnesia, titania, zirconia. Other suitable support materials, however, can be employed, for example, finely divided functionalized polyolefins, such as finely divided polyethylene. Examples of suitable supports may include magnesia, titania, zirconia, montmorillonite, phyllosilicate, zeolites, talc, clays. Also, combinations of these support materials may be used, for example, silica-chromium, silica-alumina, silica-titania. In at least one embodiment, the support material is selected from Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area of about 10 m²/g to about 700 m²/g, pore volume of about 0.1 cm³/g to about 4.0 cm³/g and average particle size of about 5 μm to about 500 μm. The surface area of the support material can be of about 50 m²/g to about 500 m²/g, pore volume of about 0.5 cm³/g to about 3.5 cm³/g and average particle size of about 10 μm to about 200 μm. For example, the surface area of the support material can be about 100 m²/g to about 400 m²/g, pore volume of about 0.8 cm³/g to about 3.0 cm³/g and average particle size can be about 5 μm to about 100 μm. The average pore size of the support material useful in the present disclosure can be of about 10 Å to about 1000 Å, such as about 50 Å to about 500 Å, and such as about 75 Å to about 350 Å. In at least one embodiment, the support material is a high surface area, amorphous silica (surface area=300 m²/gm; pore volume of 1.65 cm³/gm). For example, suitable silicas can be the silicas marketed under the tradenames of DAVISON™ 952 or DAVISON™ 955 by the Davison Chemical Division of W.R. Grace and Company. In other embodiments, DAVISON™ 948 is used. Alternatively, a silica can be ES-70™ silica (PQ Corporation, Malvern, Pennsylvania) that has been calcined, for example (such as at 875° C.).

The support material should be dry, that is, free or substantially free of absorbed water. Drying of the support material can be effected by heating or calcining at about 100° C. to about 1000° C., such as at least about 600° C. When the support material is silica, it is heated to at least 200° C., such as about 200° C. to about 850° C., and such as at about 600° C.; and for a time of about 1 minute to about 100 hours, about 12 hours to about 72 hours, or about 24 hours to about 60 hours. The calcined support material must have at least some reactive hydroxyl (OH) groups to produce supported catalyst systems of the present disclosure. The calcined support material is then contacted with at least one polymerization catalyst including at least one catalyst compound and an activator.

The support material, having reactive surface groups, such as hydroxyl groups, is slurried in a non-polar diluent and the resulting slurry is contacted with a solution of a catalyst compound and an activator. In at least one embodiment, the slurry of the support material is first contacted with the activator for a period of time of about 0.5 h to about 24 h, about 2 h to about 16 h, or about 4 h to about 8 h. The solution of the catalyst compound is then contacted with the isolated support/activator. In at least one embodiment, the supported catalyst system is generated in situ. In alternate embodiments, the slurry of the support material is first contacted with the catalyst compound for a period of time of about 0.5 h to about 24 h, about 2 h to about 16 h, or about 4 h to about 8 h. The slurry of the supported catalyst compound is then contacted with the activator solution.

The mixture of the catalyst(s), activator(s) and support is heated about 0° C. to about 70° C., such as about 23° C. to about 60° C., such as at room temperature. Contact times can be about 0.5 hours to about 24 hours, such as about 2 hours to about 16 hours, or about 4 hours to about 8 hours.

Suitable non-polar diluents are materials in which all of the reactants used herein, e.g., the activator and the catalyst compound, are at least partially soluble and which are liquid at polymerization temperatures. Non-polar diluents can be alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

In at least one embodiment, the support material is a supported methylalumoxane (SMAO), which is an MAO activator treated with silica (e.g., ES-70-875 silica).

### Polyethylene Copolymers

The present disclosure provides polyethylene copolymers having a useful combination of medium density (or high density), high molecular weight, low comonomer incorporation, high melt index ratio, low melt index, and long chain branching. This makes these polyethylene copolymers useful in various film applications demanding a good balance of strength and processability; but it also makes the catalysts and catalyst systems described herein useful as potential candidates for dual catalyst systems (wherein the catalysts described herein could be useful in producing a high-molecular-weight, high-density (low comonomer incorporation) fraction of polyethylene when combined with a catalyst compound used for producing lower-molecular weight polyethylenes).

Thus, polyethylene copolymers made using the catalyst systems of the present disclosure in general can exhibit one or more of the following properties:
Density of about 0.925 to about 0.955 g/cm³, such as from a low of any one of 0.925, 0.93, 0.935, 0.94, 0.945, or 0.95 g/cm³ to a high of any one of 0.93, 0.935, 0.94, 0.945, 0.95, 0.952, or 0.955 g/cm³, such as about 0.93 g/cm³ to about 0.940 g/cm³, alternatively about 0.94 g/cm³ to about 0.95 g/cm³, with combinations from any low to any high contemplated (provided the high end is greater than the low end), e.g., about 0.94 to about 0.955 g/cm³.
Melt Index (MI, also referred to as I₂ or I_{2.16} in recognition of the 2.16 kg loading used in the test) of about 0.1 to about 10 g/10 min (ASTM D1238, 190° C., 2.16 kg), such as from a low of any one of 0.01, 0.05, 0.1, 0.3, 0.5, 0.7, 0.9, 1, 1.1, 1.2, 1.5, 2, 2.1, 2.2, 2.5, 3, 3.5, 4, 4.5, 5, 5.5, 6, 6.5, 7, 7.5, or 8 g/10 min to a high end of any one of 0.5, 1, 1.5, 2, 2.5, 3, 3.5, 4, 4.5, 5, 5.5, 6, 6.5, 7, 7.5, 8, 8.5, 9, 9.5, 10, 10.5, or 11 g/10 min, with ranges from any low end to any high end contemplated herein (provided the high end is greater than the low end), such as about 0.1 to about 1 g/10 min, alternatively about 1 to about 3 g/10 min, alternatively about 7 to about 10 g/10 min.

Expounding further, the polyethylene copolymer may be the polymerization product of an ethylene monomer and one or more olefin comonomers, such as alpha-olefin comonomers. Alpha-olefin comonomers can have 3 to 12 carbon atoms, or from 4 to 10 carbon atoms, or from 4 to 8 carbon atoms. Olefin comonomers can be selected from propylene, 1-butene, 1-pentene, 1-hexene, 1-heptene, 1-octene, 4-methylpent-1-ene, 1-nonene, 1-decene, 1-undecene, 1-dodecene, 1-hexadecene, and the like, and any combination thereof, such as 1-butene, 1-hexene, and/or 1-octene. In some embodiments, a polyene is used as a comonomer. In some embodiments, the polyene is selected from 1,3-hexadiene, 1,4-hexadiene, cyclopentadiene, dicyclopentadiene, 4-vinylcyclohex-1-ene, methyloctadiene, 1-methyl-1,6-octadiene, 7-methyl-1,6-octadiene, 1,5-cyclooctadiene, norbornadiene, ethylidene norbornene, 5-vinylidene-2-norbornene, 5-vinyl-2-norbornene, and/or olefins formed in situ in the polymerization medium. In some embodiments, comonomers are selected from isoprene, styrene, butadiene, isobutylene, chloroprene, acrylonitrile, and/or cyclic olefins. In some embodiments, combinations of the olefin comonomers are utilized. In some embodiments, the olefin comonomer is selected from 1-butene and/or 1-hexene. The olefin comonomer content of the polyethylene copolymer can range from a low of about 0.1, 0.3, 0.5, 0.7, 0.9, 1.1, 1.3, 1.5, 1.7, 1.9, 2.1, 2.3, or 2.5 wt % to a high of about 1.5, 1.7, 1.9, 2.1, 2.3, 2.5, 2.7, 2.9, 3.1, 3.3, or 3.5 wt %, on the basis of total weight of monomers in the polyethylene copolymer. The balance of the polyethylene comonomer is made up of units derived from ethylene (e.g., from a low of about 80, 85, 90, 95, 96, 97, 97.5, 98, 98.5, 99, or 99.5 wt % to a high of about 90, 95, 97, 97.5, 98, 98.5, 99, 99.5, or 99.9 wt %). Ranges from any foregoing low end to any foregoing high end are contemplated herein (e.g., about 97 to about 98.5 wt %, such as about 97.5 to about 98.5 wt % ethylene-derived units and the balance olefin comonomer-derived content).

### Molecular Weight Properties

The polyethylene copolymers can also have a molecular weight distribution (MWD) of about 3 to about 10. The MWD can also range from a low of about 3, 3.5, 4, 4.5, 5, 5.5, 6, 6.5, or 7 to a high of about 6.5, 7, 7.5, 8, 8.5, 9, 9.5, or 10, with ranges from any foregoing low to any foregoing high contemplated, provided the high end of the range is greater than the low end. MWD is defined as the weight average molecular weight (Mw) divided by number-average molecular weight (Mn).

Weight-average molecular weight (Mw) of polyethylene copolymers of various embodiments may be within the range from about 50,000 to about 300,000 g/mol, such as about 60,000 to about 150,000 g/mol, such as about 65,000 to about 100,000 g/mol, such as about 70,000 to about 90,000 g/mol, alternatively about 120,000 to about 200,000 g/mol, such as about 150,000 to about 175,000 g/mol, with ranges from any foregoing low end to any foregoing high end contemplated.

Number-average molecular weight (Mn) of polyethylene copolymers of various embodiments may be within the range from about 5,000 to about 50,000 g/mol, such as about 5,000 to about 25,000 g/mol, such as about 5,000 to about 15,000 g/mol, alternatively about 18,000 to about 30,000 g/mol, such as about 20,000 to about 25,000 g/mol, with ranges from any foregoing low end to any foregoing high end contemplated.

Z-average molecular weight (Mz) of polyethylene copolymers of various embodiments may be within the range from about 300,000 to about 2,000,000 g/mol, such as about 500,000 to about 2,000,000 g/mol, or about 800,000 to about 1,000,000 g/mol, alternatively about 1,000,000 g/mol to about 2,000,000 g/mol, such as about 1,200,000 g/mol to about 1,800,000 g/mol, such as about 1,400,000 to about 1,600,000 g/mol, with ranges from any foregoing low end to any foregoing high end contemplated.

### Composition Distribution

Polyethylene copolymers as described herein have a relatively consistent comonomer distribution, meaning that shorter and longer polymer chains among the population of polymer chains in the copolymers have somewhat similar relative loadings of comonomer (that is, similar amounts of short chain branching per 1000 carbon atoms), with some variation. This relatively even comonomer distribution could, for instance, be due to the middle- to high-density ranges of polyethylenes described herein (particularly around 0.933 to about 0.950), which means there is relatively less comonomer incorporation overall as compared to LLDPEs (having lower density, and thus generally higher comonomer incorporation). This comonomer distribution can be characterized in various ways.

For instance, the polyethylene copolymers described herein can have a middling to high composition distribution breadth index (CBDI), in which the polyethylene copolymers may have a CBDI % of about 40% to about 70%, such as from a low of any one of 40, 42, or 44% to a high of any one of 50, 55, 60, 65, or 70%, with ranges from any foregoing low end to any foregoing high end contemplated. CDBI is defined as the weight percent of the copolymer molecules having a comonomer content within +/−50% of the median comonomer mol % value, as described at pp. 18-19 of WO 1993/003093 in conjunction with FIG. 17 therein. This means that for a copolymer having median comonomer mol % value (Cmed) of 8 mol % comonomer on a polymer chain, CDBI is the wt % of copolymer chains having comonomer mol % that is between (0.5×Cmed) and (1.5×Cmed). In this example, CDBI is the wt % of copolymer chains having comonomer mol % between (0.5×8) and (1.5×8), or comonomer content between 4 mol % and 12 mol %. WO 1993/003093 also describes the process for determining the weight fraction of polymer vs. composition curve (i.e., the composition distribution curve) using chromatography and C13 NMR, and determining the median comonomer composition Cmed therefrom, with reference to FIGS. 16 and 17 of that publication. The CDBI of a copolymer is readily determined utilizing a technique for isolating individual fractions of a sample of the copolymer. One such technique is generation of a solubility distribution curve using Temperature Rising Elution Fraction (TREF), as described in WO 1993003093 (which in turn references Wild, et al., J. Poly. Sci., Poly. Phys. Ed., vol. 20, p. 441 (1982) and U.S. Pat. No. 5,008,204 in this regard). All three of the foregoing publications are incorporated herein by reference.

The solubility distribution curve can be first generated for the copolymer using data acquired from TREF techniques (as described, e.g., in the just-referenced publications). This solubility distribution curve is a plot of the weight fraction of the copolymer that is solubilized as a function of temperature. This can be converted to a weight fraction versus composition distribution curve. For the purpose of simplifying the correlation of composition with elution temperature the weight fractions less than 15,000 can be ignored. These low weight fractions generally represent a trivial portion of the ethylene-based polymers disclosed herein.

Alternatively or additionally, the composition distribution can be characterized by the T₇₅−T₂₅ value, wherein T₂₅ is the temperature at which 25% of the eluted polymer is obtained and T₇₅ is the temperature at which 75% of the eluted polymer is obtained, both in a TREF experiment (and plotting of eluted polymer molecular weights vs. elution temperatures) as described in US2019/0119413 (especially in paragraphs-thereof, which description is incorporated by reference herein). A narrow composition distribution is reflected in a relatively small difference in the T₇₅−T₂₅ value, while a broad distribution is reflected in a relatively larger difference in the T₇₅−T₂₅ value, implying greater differences in crystallinity between fractions of the polymer composition. It is also noted that, in the event of discrepancies between the actual TREF procedure as described in US2019/0119413 vs. the TREF procedure as described in WO 1993003093, U.S. Pat. Nos. 5,382,630, and/or 5,008,204, the TREF procedure as described in US2019/0119413 should be used. (Note further that the curves generated ancillary to the TREF procedures-solubility distribution curve for CDBI, and eluted molecular weights vs elution temperature for T₇₅−T₂₅, may have appropriate differences in their generation and analysis for CDBI and T₇₅−T₂₅.) Finally, the TREF curve (eluted polymer molecular weights vs elution temperatures) generated in connection with T₇₅−T₂₅ measurements can be further processed as follows:
1. The solvent-only response of the instrument can be generated and subtracted from the TREF curve of the sample. The solvent-only response can be generated by running, typically before, the same method as used for the polymer sample, but without any polymer added to the sample vial; using the same solvent reservoir as for the polymer sample and without replenishing with fresh solvent; and within a reasonable proximity of time from the run for the polymer sample.
2. The temperature axis of the TREF curve can be appropriately shifted to correct for the delay in the IR signal caused by the column-to-detector volume. This volume can be obtained by first filling the injection-valve loop with a ~1 mg/ml solution of an HDPE resin; then loading the loop volume in the same location within the column where a sample is loaded for TREF analysis; then directly flowing, at a constant flow rate of 1 ml/min, the hot solution towards the detector using an isothermal method; and then measuring the time after injection for the HDPE probe's peak to appear in the IR signal. The delay volume (ml) is therefore equated to the time (min).
3. The curve can be baseline corrected and appropriate integration limits can be selected; and the curve can be normalized so that the area of the curve is 100 wt %.

A narrow distribution is reflected in the relatively small difference in the T₇₅−T₂₅ value being less than 10° C., such as within the range from 2 to 10° C., such as from a low of any one of about 2, 2.5, 3, 3.5, 4, 4.5, 5, 5.5, or 6° C. to a high of any one of about 10, 9.5, 9, 8.5, 8, 7.5, 7, 6.5, 6, 5.5, 5, 4.5, or 4° C., with combinations from any low to any high contemplated (provided the high end is greater than the low end), e.g., from about 2° C. to about 8° C.

The distributions and the moments of molecular weight (Mw, Mn, Mw/Mn, etc.), and the branching index (g′vis) are determined by using a high temperature Gel Permeation Chromatography (Polymer Char GPC-IR) equipped with a multiple-channel band-filter based Infrared detector IR5, an 18-angle Wyatt Dawn Heleos light scattering detector and a 4-capillary viscometer with Wheatstone bridge configuration. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 ml/min and the nominal injection volume is 200 μL. The whole system including transfer lines, columns, and viscometer detector are contained in ovens maintained at 145° C. The polymer sample is weighed and sealed in a standard vial with 80-μL flow marker (Heptane) added to it. After loading the vial in the autosampler, polymer is automatically dissolved in the instrument with 8 ml added TCB solvent. The polymer is dissolved at 160° C. with continuous shaking for about 2 hour. The concentration (c), at each point in the chromatogram is calculated from the baseline-subtracted IR5 broadband signal intensity (I), using the following equation: c=βI, where β is the mass constant. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10 million g/mol. The MW at each elution volume is calculated with the following equation:

$$log M = \frac{log ( {K}_{P S} / K )}{a + 1} + \frac{{a}_{P S} + 1}{a + 1} log {M}_{P S}$$

where the variables with subscript “PS” stand for polystyrene while those without a subscript are the test samples. In this method, α_{PS}=0.67 and K_{PS}=0.000175 while α and K are for ethylene-hexene copolymers as calculated from empirical equations (Sun, T. et al. Macromolecules 2001, 34, 6812), in which a=0.695 and K=0.000579 (1−0.75Wt), where Wt is the weight fraction for hexene comonomer. It should be noted that the comonomer composition is determined by the ratio of the IR5 detector intensity corresponding to CH₂ and CH₃ channel calibrated with a series of PE and ethylene-hexene homo/copolymer standards whose nominal values are predetermined by NMR or FTIR. Here the concentrations are expressed in g/cm³, molecular weight is expressed in g/mol, and intrinsic viscosity (hence K in the Mark-Houwink equation) is expressed in dL/g.

The LS molecular weight (M) at each point in the chromatogram is determined by analyzing the LS output using the Zimm model for static light scattering

$$\frac{{K}_{o} c}{Δ R ( θ )} = \frac{1}{M P ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Ko is the optical constant for the system:

$${K}_{o} = \frac{4 {π}^{2} {{n}^{2} ( dn / d c )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm. For purposes of the present disclosure and the claims thereto (dn/dc)=0.1048 for ethylene-hexene copolymers.

Viscosity-average molecular weight (M_{V}): A high temperature Polymer Char viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as M=K_{PS}M^{α}^{_{PS}}⁺¹/[η] where aps is 0.67 and Kps is 0.000175. The average intrinsic viscosity [η]_{avg} of the sample is calculated by

$${[ η ]}_{a v g} = \frac{\sum {{c}_{i} [ η ]}_{i}}{\sum {c}_{i}}$$

where the summations are over the chromatographic slices, i, between the integration limits.

The branching index (g′ᵥᵢₛ) can be calculated using the output of the GPC-IR5-LS-VIS method as follows. First, it is noted that g′ or g′ᵥᵢₛ can in general be considered the ratio of a polymer's intrinsic viscosity to that of a linear polymer of the same molecular weight and composition: g′=[η_{polymer}]/[η_{reference}], where [η_{polymer}] is the intrinsic viscosity of the polymer under investigation and [η_{reference}] is the intrinsic viscosity of a linear resin of the same composition with the same molecular weight. A polymer's relative intrinsic viscosity (g′) is therefore a measure of how much the polymer enhances its solution's viscosity relative to how much a linear polymer of the same molecular weight and composition enhances its solution's viscosity, under the same conditions of temperature and pressure.

Following this principle, the [η_{polymer}] value in the above simplified relationship may be taken as the weight-average intrinsic viscosity, [η]_{avg}, of the sample, which is calculated by:

$${[ η ]}_{a v g} = \frac{\sum {{c}_{i} [ η ]}_{i}}{\sum {c}_{i}}$$

where the summations are over the chromatographic slices, i, between the integration limits. The branching index g′ᵥᵢₛ is defined against the linear reference as

$${g}_{vis}^{′} = \frac{{[ η ]}_{avg}}{K {M}_{v}^{α}} ,$$

where M_{V} is the viscosity-average molecular weight based on molecular weights determined by LS analysis and the K and α are for the reference linear polymer; for purposes of the present disclosure, α and K are the same as described above for linear polyethylene polymers.

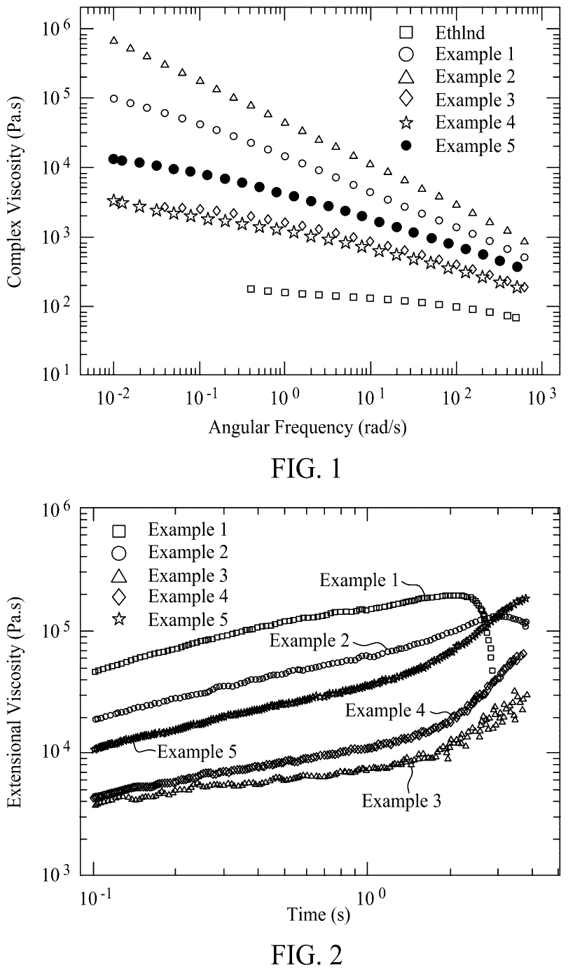

The branching index g′ᵥᵢₛ may equivalently be referred to as g′_{vis ave} to reflect that it is an average value of g′ determined at each of multiple discrete concentration slices. For example, with reference to FIG. 1, one can see g′ for various polyethylene copolymers plotted as a function of Log M (log of molecular weight), implying a g′ value can be calculated for a given molecular weight population of polymer chains in the polyethylene copolymer composition. The above calculations provide the g′_{vis ave} as a weighted average of these multiple g′ values, and the g′_{vis ave} can be taken as a good relative indicator of the presence of long chain branching when comparing such value between two different copolymer compositions, with lower g′_{vis ave} indicating greater long chain branching.

### Further Polyethylene Copolymer Rheology

In addition to the melt index (MI) values noted previously, the polyethylene copolymers can also have a high load melt index (HLMI) (also referred to as I₂₁ or I_{21.6} in recognition of the 21.6 kg loading used in the test) within the range from a low of about 5, 25, 50, 75, 100, 125, 150, 175, 200, or 225 g/10 min to a high of about 20, 50, 100, 150, 200, 225, 250, 275, 300, or 325 g/10 min; with ranges from any of the foregoing lows to any of the foregoing highs contemplated herein (e.g., about 5 to about 20 g/10 min, alternatively about 25 to about 50 g/10 min, alternatively about 200 to about 300 g/10 min). The term “high load melt index” (“HLMI”), is the number of grams extruded in 10 minutes under the action of a standard load (21.6 kg) and is an inverse measure of viscosity. As provided herein, HLMI (I₂₁) is determined according to ASTM D1238 (190° C./21.6 kg) and is also sometimes referred to as I₂₁ or I_{21.6}.

Accordingly, the polyethylene copolymers can also have a melt index ratio (MIR, defined as the ratio of I_{21.6}/I_{2.16}) within the range from a low of any one of about 20, 30, 40, 50, 60, 70, 80, 90, 100, 110, 120, 130, 140, or 150 to a high of any one of about 30, 40, 50, 60, 70, 80, 90, 100, 110, 120, 130, 140, 150, 160, 170, 180, 190, 200 with ranges from any of the foregoing lows to any of the foregoing highs contemplated herein (e.g., about 20 to about 40, alternatively about 120 to about 180).

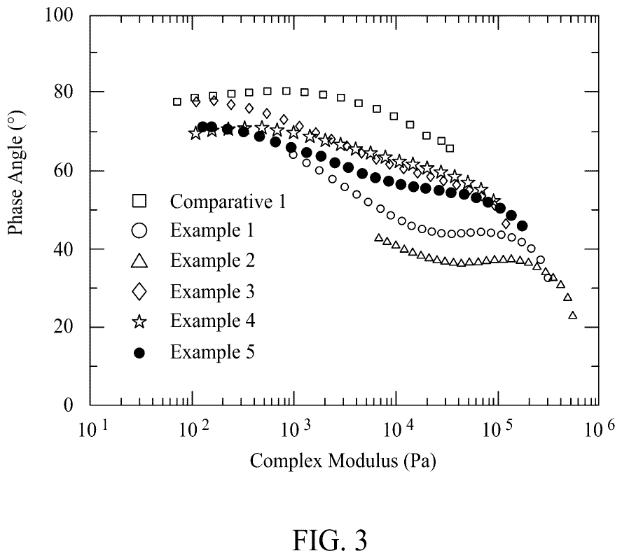

Polyethylene copolymers of various embodiments may also exhibit moderate long-chain branching; less than incumbent LDPE (produced in free radical polymerization with large variations in, and little control over, polymer branching directions), but more than typical metallocene LLDPE. This moderate amount of LCB can be evidenced through, e.g., a high MIR (discussed above) and/or particular rheology characteristics as shown through data obtained by SAOS experiments (such as ratio of η_{0.01}/η₁₀₀, the raio of complex viscosity recorded at shear rates or frequencies of 0.01 and 100 rad/s, respectively). Another useful parameter for indicating the presence of LCB is illustrated in FIG. 3: Van Gurp Palmen (VGP) plots. In particular, polyethylene copolymers (even LLDPE) with some to moderate degree of LCB can have a VGP curve with a portion having generally negative slope, but with what is referred to herein as an “inflection point” in the VGP curve (wherein such point could constitute noticeable reduction in the magnitute of negative slope, flattening of slope, or even direction change in the slope, before resumption of the negative-sloping trend in said portion of the curve), while LLDPE with little or no LCB present do not follow this characteristic pattern. See FIG. 3, Comparative 1 (no inflection) vs. Examples 1, 2, and 3.

Further, LCB index (g′ or alternatively g′vis) could be less than 1, such as within the range from about 0.7 to about 0.99, such as about 0.85 to about 0.97, such as about 0.87 to about 0.96, such as about 0.89 to about 0.92, alternatively about 0.92 to about 0.96, with ranges from any foregoing low end to any foregoing high end contemplated.

Thus, expanding on the foregoing, the polyethylene copolymers can have a complex shear viscosity (η*)@0.01 rad/sec and 190° C. in the range of 1,000 to 700,000 Pa·s, such as from a low of any one of 1,000, 15,000, 30,000, 45,000, 60,000, 75,000, 90,000, or 105,000 Pa·s to a high of any one of 700,000, 685,000, 670,000, 655,000, 640,000, 625,000, 610,000, 595,000, 580,000, or 565,000 Pa·s, with ranges from any low end to any high end contemplated (for example, from 1,000 to 30,000 Pa·s or from 30,000 to 60,000 Pa·s).

Complex shear viscosity (η*)@100 rad/sec and 190° C. may be in the range from 300 to 3,000 Pa·s, such as from a low of any one of 300, 500, 700, 900, 1,100, 1,300, or 1,500 Pa·s to a high of any one of 3,000, 2,800, 2,600, 2,400, 2,200, 2,000, or 1,800 Pa·s, with ranges from any foregoing low to any foregoing high also contemplated (for example, from 300 to 700 Pa·s or from 700 to 1,100 Pa·s).

Therefore, the polyethylene copolymers may also exhibit a higher shear thinning index (STI 0.1/100). STI 0.1/100 data measures the ratio of complex viscosities at 0.1 and 100 rad/s. STI 0.1/100 data of polyethylene copolymers of various embodiments may be greater than 5, such as greater than 6 or even higher. For instance, STI0.1/100 may be within the range from a low of any one of about 5, 10, 15, 20, 25, 30, 35, 40, 45, 50, 55 to a high of any one of about 70, 65, 60, 55, 50, 45, 40, 35, 30, 25, 20, 15, or 10, with ranges from any foregoing low to any foregoing high also contemplated (for example, about 5 to 10, 30, 40, or 50; or from about 20 to 65; or 5 to 65; etc.).

The polyethylene copolymers may also exhibit lower phase angles at 10 kPA complex modulus as compared to typical metallocene PEs. Phase angle data measures the viscous and elastic properties of a material. Phase angle data of polyethylene copolymers of various embodiments may be within the range of about 35 to about 65 degrees at 10 kPa, such as about 40 to about 65, such as about 40 to about 50, alternatively about 55 to about 65.

In some embodiments, a polyethylene copolymer has a G′/G″@0.1 s⁻¹ value (which is a ratio of shear storage modulus (Pa) to shear loss modulus (Pa) at 0.1 s-1) of about 0.2 to about 2, such as about 0.5 to about 2, such as about 0.5 to about 1, alternatively about 1 to about 2, such as about 1 to about 1.5.

Rheological data such as “Complex shear viscosity (η*),” reported in Pascal seconds, can be measured at 0.01 rad/sec and 100 rad/sec. Complex shear viscosity and other rheological measurements can be obtained from small angle oscillatory shear (SAOS) experiments.

For instance, complex shear viscosity can be measured with a rotational rheometer such as an Advanced Rheometrics Expansion System (ARES-G2 model) or Discovery Hybrid Rheometer (DHR-3 Model) using parallel plates (diameter=25 mm) in a dynamic mode under nitrogen atmosphere. The rheometer can be thermally stable at 190° C. for at least 20 minutes before inserting compression-molded specimen onto the parallel plates. To determine the specimen's viscoelastic behavior, a frequency sweep in the range from 0.01 to 628 rad/s can be carried out at a temperature of 190° C. under constant strain that does not affect the measured viscoelastic properties. The sweep frequencies are equally spaced on a logarithmic scale, so that 5 frequencies are probed per decade. Depending on the molecular weight and temperature, strains of 3% can be used and linearity of the response is verified. A nitrogen stream is circulated through the oven to minimize chain extension or cross-linking during the experiments. The specimens can be compression molded at 190° C., without stabilizers. A sinusoidal shear strain can be applied. If the strain amplitude is sufficiently small the material behaves linearly. As those of ordinary skill in the art will be aware, the resulting steady-state stress will also oscillate sinusoidally at the same frequency but will be shifted by a phase angle δ with respect to the strain wave. The stress leads the strain by δ. For purely elastic materials δ=0° (stress is in phase with strain) and for purely viscous materials, δ=90° (stress leads the strain by 90° although the stress is in phase with the strain rate). For viscoleastic materials, 0<δ<90. Complex viscosity, loss modulus (G″) and storage modulus (G′) as function of frequency are provided by the small amplitude oscillatory shear test. Dynamic viscosity is also referred to as complex viscosity or dynamic shear viscosity. The phase or the loss angle δ, is the inverse tangent of the ratio of G″ (shear loss modulus) to G′ (shear storage modulus). The shear thinning slope (STS) can be measured using plots of the logarithm (base ten) of the dynamic viscosity versus logarithm (base ten) of the frequency. The slope is the difference in the log (dynamic viscosity) at a frequency of 100 s⁻¹ and the log (dynamic viscosity) at a frequency of 0.01 s⁻¹ divided by 4. The complex shear viscosity (η*) versus frequency (ω) curves can be fitted using the Carreau-Yasuda model:

$$η * - η∞ = ( {η}_{0} - η∞ ) * {( 1 + {( λω )}^{a} )}^{( n - 1 ) / a} .$$

The five parameters in this model are: η₀, the zero-shear viscosity; λ, the relaxation time; and n, the power-law index; η∞, the infinite rate viscosity; and a, the transition index. The zero-shear viscosity is the value at a plateau in the Newtonian region of the flow curve at a low frequency, where the dynamic viscosity is independent of frequency. The relaxation time corresponds to the inverse of the frequency at which shear-thinning starts. The power-law exponent describes the extent of shear-thinning, in that the magnitude of the slope of the flow curve at high frequencies approaches n−1 on a log (η*)−log (ω) plot. For Newtonian fluids, n=1 and the dynamic complex viscosity is independent of frequency.

In addition to dynamic and complex viscosity (each in Pascal seconds), at each frequency sweep in the SAOS experiment, various other parameters are collected, including storage modulus (Pa), Loss modulus (Pa), Complex Modulus (Pa), tan(delta), and phase angle. Charting the phase angle versus the complex shear modulus from the rheological experiment yields Van Gurp Palmen plots useful to extract some information on the molecular characteristics, for example, linear vs. long chain branched chains, type of long chain branching, polydispersity (Dealy, M. J., Larson, R. G., “Structure and Rheology of Molten Polymers”, Carl Hanser Verlag, Munich 182-183 (2006). It has been also suggested that Van Gurp Palmen plots can be used to reveal the presence of long chain branching in polyethylene. See Trinkle, S., Walter, P., Friedrich, C. “Van Gurp-Palmen plot II—Classification of long chain branched polymers by their topology”, in 41 Rheol. Acta 103-113 (2002).

“Shear Thinning Index”, which is reported as a unitless number, is characterized by the decrease of the complex viscosity with increasing shear rate. Herein, shear thinning can be determined as a ratio of complex viscosity at a frequency of 0.01 rad/s to the complex viscosity at a frequency of 100 rad/s.

Extensional viscosity can be measured at 190° C. using a SER2-P testing Platform available from Xpansion Instruments LLC, Tallmadge, Ohio, USA. The sample can be prepared placing the polymer in a mold measuring approximately 50 mm×50 mm with a thickness of ~0.5 mm. The mold can be pressed in a carver laboratory press with a 3 pressure stage procedure at 190° C.: The material can be preheated with 0 pounds of pressure for 2 minutes, pressed at 5 k lbs of pressure for 2 minutes, then the pressure can be maintained at 0 while still in the mold for 15 minutes. Samples can be cut into test strips, e.g. measuring between 13 and 13.4 mm in width, ~18 mm in length, and between 0.5 mm and 0.6 mm in average thickness. Note that there is variation in dimensions due to sample type. Samples can be tested on an MCR 501 rheometer with an SER testing fixture. Samples can be temperature equilibrated for 10-15 minutes before the test. The SER Testing Platform can be used on a MCR501 rheometer available from Anton Paar. The SER Testing Platform is described in U.S. Pat. Nos. 6,578,413 and 6,691,569, which are incorporated herein for reference. A general description of transient uniaxial extensional viscosity measurements is provided, for example, in “Measuring the transient extensional rheology of polyethylene melts using the SER universal testing platform”, The Society of Rheology, Inc., J. Rheol. 49 (3), 585-606 (2005). Strain hardening occurs when a polymer is subjected to elongational flow and the transient extensional viscosity increases with respect to the linear viscoelasticity envelop (LVE). Strain hardening is observed as abrupt upswing of the extensional viscosity in the transient extensional viscosity vs. time plot. A strain hardening ratio (SHR) is used to characterize the upswing in extensional viscosity and is defined as the ratio of the maximum transient extensional viscosity at certain strain rate over the respective value of the LVE. Strain hardening is present in the material when the ratio is greater than 1.

### Blends and Additives

In some embodiments, the polyethylene copolymers can be formulated (e.g., blended) with one or more other polymer components. In some embodiments, those other polymer components are alpha-olefin polymers such as polypropylene or polyethylene homopolymer and copolymer compositions. In some embodiments, those other polyethylene polymers are selected from linear low density polyethylene, high density polyethylene, medium density polyethylene, low density polyethylene, or other differentiated polyethylenes.

In some embodiments, the formulated blends can contain additives, which are determined based upon the end use of the formulated blend. In some embodiments, the additives are selected from fillers, antioxidants, phosphites, anti-cling additives, tackifiers, ultraviolet stabilizers, heat stabilizers, antiblocking agents, release agents, antistatic agents, pigments, colorants, dyes, waxes, silica, processing aids, neutralizers, lubricants, surfactants, nucleating agents, or any combination thereof. In some embodiments, additives are present in an amount from about 0.1 ppm to about 5 wt %.

Polyethylene copolymers of the present disclosure can be optionally blended with one or more processing aids to form a polyethylene blend. Because of the improved properties of polyethylene copolymers of the present disclosure, advantageously, such processing aids can be omitted even in blown films (e.g., films, and particularly blown films, of some embodiments may be free of or substantially free of polymer processing aids, and especially polymer processing aids comprising fluorine; where “substantially free” means free of any intentionally added components, but allowing for up to 100 ppm of such component(s) as impurities).

### Articles of Manufacture

The polyethylene copolymers of the present disclosure can be particularly suitable for making end-use articles of manufacture such as films (e.g., as may be formed by lamination, extrusion, coextrusion, casting, and/or blowing); as well as other articles of manufacture as may be formed, e.g., by rotomolding or injection molding. Polyethylene copolymers can be formed into articles of manufacture by cast film extrusion, blown film extrusion, rotational molding or injection molding processes. In some embodiments, the polyethylene copolymer can be used in a blend.

Polyethylene copolymers of the present disclosure may provide excellent shear thinning characteristics with little or no melt fracture of the extrudate at high die shear rates. Further, polyethylene copolymers of the present disclosure may provide films formed with reduced motor load and melt pressure (which increases input) due to improved flow behavior, as compared to other LLDPEs.

A polyethylene copolymer (or blend thereof) of the present disclosure can be useful in such forming operations as film, sheet, and fiber extrusion and co-extrusion as well as blow molding, injection molding, and rotary molding. Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, membranes, etc., in food-contact and non-food contact applications. For example, polyethylene copolymers of the present disclosure provide improved shrink wrap capability due to long chain branching properties. Fibers include melt spinning, solution spinning and melt blown fiber operations for use in woven or non-woven form to make filters, diaper fabrics, medical garments, geotextiles, etc. Extruded articles include medical tubing, wire and cable coatings, pipe, geomembranes, and pond liners. Molded articles include single and multi-layered constructions in the form of bottles, tanks, large hollow articles, rigid food containers and toys, etc.

The polyethylene copolymers (or blends thereof) may be formed into monolayer or multilayer films. These films may be formed by any of the conventional techniques including extrusion, co-extrusion, extrusion coating, lamination, blowing and casting. The film may be obtained by the flat film or tubular process which may be followed by orientation in a uniaxial direction or in two mutually perpendicular directions in the plane of the film. One or more of the layers of the film may be oriented in the transverse and/or longitudinal directions to the same or different extents. This orientation may occur before or after the individual layers are brought together. For example a polyethylene copolymer (or blend thereof) layer can be extrusion coated or laminated onto an oriented polypropylene layer or the polyethylene copolymer (or blend thereof) and polypropylene can be coextruded together into a film then oriented. Likewise, oriented polypropylene could be laminated to oriented polyethylene copolymer (or blend thereof), or oriented polyethylene copolymer (or blend thereof) could be coated onto polypropylene then optionally the combination could be oriented even further.

Films include monolayer or multilayer films. Particular end use films include, for example, blown films, cast films, stretch films, stretch/cast films, stretch cling films, stretch handwrap films, machine stretch wrap, shrink films, shrink wrap films, greenhouse films, laminates, and laminate films. Exemplary films are prepared by any conventional technique known to those skilled in the art, such as for example, techniques utilized to prepare blown, extruded, and/or cast stretch and/or shrink films (including shrink-on-shrink applications).

In at least one embodiment, multilayer films (multiple-layer films) may be formed by any suitable method. The total thickness of multilayer films may vary based upon the application desired. A total film thickness of 5-100 μm, such as 10-50 μm, is suitable for most applications. Those skilled in the art will appreciate that the thickness of individual layers for multilayer films may be adjusted based on desired end-use performance, polymer(s) employed, equipment capability, and other factors. The materials forming each layer may be coextruded through a coextrusion feedblock and die assembly to yield a film with two or more layers adhered together but differing in composition. Coextrusion can be adapted for use in both cast film or blown film processes. Exemplary multilayer films have at least two, at least three, or at least four layers. In one embodiment the multilayer films are composed of five to ten layers.

### Shrink Films

Compositions of the present disclosure may be utilized to prepare shrink films. Shrink films, also referred to as heat-shrinkable films, are widely used in both industrial and retail bundling and packaging applications. Such films are capable of shrinking upon application of heat to release stress imparted to the film during or subsequent to extrusion. The shrinkage can occur in one direction or in both longitudinal and transverse directions. Conventional shrink films are described, for example, in U.S. Pat. No. 7,235,607, incorporated herein by reference.

Industrial shrink films can be used for bundling articles on pallets. Typical industrial shrink films are formed in a single bubble blown extrusion process to a thickness of about 80 to 200 μm, and provide shrinkage in two directions.

Retail films can be used for packaging and/or bundling articles for consumer use, such as, for example, in supermarket goods. Such films are typically formed in a single bubble blown extrusion process to a thickness of about 35 μm to about 80 μm.

Films may be used in “shrink-on-shrink” applications. “Shrink-on-shrink,” as used herein, refers to the process of applying an outer shrink wrap layer around one or more items that have already been individually shrink wrapped (herein, the “inner layer” of wrapping). In these processes, it may be desired that the films used for wrapping the individual items have a higher melting (or shrinking) point than the film used for the outside layer. When such a configuration is used, it is possible to achieve the desired level of shrinking in the outer layer, while preventing the inner layer from melting, further shrinking, or otherwise distorting during shrinking of the outer layer. Some films described herein may have a sharp shrinking point when subjected to heat from a heat gun at a high heat setting, which indicates that they may be especially suited for use as the inner layer in a variety of shrink-on-shrink applications.

### EXPERIMENTAL

### General Considerations and Reagents.

All manipulations were performed under an inert atmosphere using glove box techniques unless otherwise stated. Diethyl ether, pentane, hexane 1,2-dimethoxyethane and Dichloromethane (Sigma Aldrich) were degassed and dried over 3 Å molecular sieves overnight prior to use. n-Butyl lithium in hexane, iodomethane were purchased from Sigma Aldrich and used as received. ZrCl₄ was purchased from Strem chemicals and used as received. Methylaluminoxane was purchased from Grace and used as received.

Relaxation Time and Cross Equation Constants: In addition to SAOS and other parameters described elsewhere herein, the relaxation time τ and/or Cross equation values (esp viscosity, time, and power law constants) may help indicate polydispersity/MWD and/or the presence of long chain branching in a polymer composition (or behavior of a polymer composition in a manner that emulates long chain branched polymers). Relaxation time τ may be determined from the Cross Equation as used to model viscosity data collected over a range of frequencies. The viscosity data collected over a range of frequency can be fitted (e.g., via the least squares method) using the general form of the Cross Equation (J. M Dealy and K. F Wissbrun, Melt Rheology and Its Role in Plastics Processing Theory and Applications; Van Nostrand Reinhold: New York, p. 162 (1990):

$$η = {η}_{∞} + \frac{{η}_{0} - {η}_{∞}}{1 + {( γτ )}^{1 - n}}$$

where η is the dynamic viscosity, η₀ is the limiting zero shear viscosity, η_{∞} is the infinite shear viscosity, τ is the relaxation time at the given input shear frequency γ, and n is the power law exponent, which can describe the extent of shear thinning. For Newtonian fluid, n=1 and the dynamic complex viscosity is independent of frequency. For polymer of interest here, n<1, so that the enhanced shear thinning behavior is indicated by a decrease in n (increase in (1−n)), and. The term η_{∞} is 0 from the curve fit, with the result the expression reduces to three parameters:

$$η = \frac{{η}_{0}}{1 + {( γτ )}^{1 - n}}$$

This expression gives the relaxation time when testing is conducted at constant strain and constant temperature. As noted, the relaxation time, τ in the Cross Model can be associated to the polydispersity and/or long chain branching in the polymer. For increased levels of branching (and/or polymer compositions emulating increased levels of branching), it is expected that t would be higher compared to a linear polymer of the same molecular weight. These three Cross parameters viscosity (η₀), time (τ), and power law (n) constants can also be labeled as Cross equation constants A1, A2, and A3, respectively.

### Catalyst Synthesis of Catalyst 19:

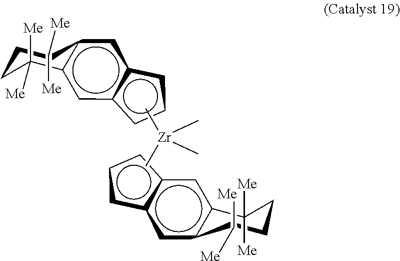

### Synthesis of (5,5,8,8-tetramethyl-6,7-dihydro-1H-cyclopenta[b]naphthalen-1-yl) lithium (1)

To a vigorously stirred white suspension of 5,5,8,8-tetramethyl-6,7-dihydro-1H-cyclopenta[b]naphthalene (20.18 g, 89.2 mmol, 1.00 equiv.) in diethyl ether (250 mL) at −35° C. was added n-Butyl Lithium in hexane (36 ml, 90.0 mmol, 1.01 equiv.) to give a cold, cloudy light yellow mixture. The reaction became cloudy bright yellow after stirring 20 minutes. The reaction was stirred overnight, then was evaporated under vacuum, leaving dirty white solid. The solid was washed with pentane (100 mL) and the solid was filtered to give a bright white solid. The yield was 18.8 g (91%) bright white powder. ¹H NMR (THF-D₈) 7.46 (s, 2H), 6.50 (t, 1H), 5.81 (dt, 1H), 1.72 (S, 4H), 1.34 (S, 12H).

### Synthesis of bis(5,5,8,8-tetramethyl-6,7-dihydro-1H-cyclopenta[b]naphthalen-1-yl) zirconium dichloride (2)

To a vigorously stirred white suspension of zirconium tetrachloride (5.00 g, 21.5 mmol, 1.00 equiv.) in diethyl ether (200 mL) at −40° C. was added (5,5,8,8-tetramethyl-6,7-dihydro-1H-cyclopenta[b]naphthalen-1-yl) lithium (1) (9.97 g, 42.9 mmol, 2.00 equiv.). The reaction was allowed to warm up to room temperature and stirred overnight, then concentrated under vacuum. The solid was extracted with dichloromethane and the extracts were filtered, then dried under vacuum. The resulting solid was washed with cold pentane and dried under vacuum, yielding a yellow solid (12.9 g, 98%). ¹H NMR (C₆D₆) 7.52 (s, 4H), 6.15 (dt, 2H), 5.82 (dt, 4H), 1.58 (m, 8H), 1.37 (s, 12H), 1.23 (s, 12H).

### Synthesis of bis(5,5,8,8-tetramethyl-6,7-dihydro-1H-cyclopenta[b]naphthalen-1-yl) zirconium dimethyl (Catalyst 19)

To a bright yellow suspension of (5,5,8,8-tetramethyl-6,7-dihydro-1H-cyclopenta[b]naphthalen-1-yl) zirconium dichloride (2) (14.6 g, 0.024 mol, 1.0 equiv) in diethyl ether (100 mL) at −35° C. was added 3 M MeMgBr in Et₂O (39.7 mL, 0.119 mol, 5.0 equiv) to give a cold, cloudy yellow mixture. The reaction mixture was stirred at room temperature overnight. Solvent was removed under vacuum. The product was extracted with pentane and dark brown solid was filtered out. Pentane was removed under vacuum resulting in the formation of pale yellow solid (yield 12.5 g, 91.6%). ¹H NMR (C₆D₆) 7.37 (s, 4H), 5.82 (dt, 4H), 5.70 (dt, 2H), 1.59 (m, 8H), 1.27 (s, 24H), −0.83 (s, 6H).

### Catalyst Synthesis of Catalyst 1:

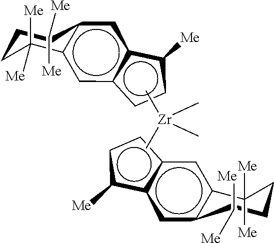

### Synthesis of (5,5,8,8-tetramethyl-6,7-dihydro-1H-cyclopenta[b]naphthalen-1-yl) lithium (1)

To a vigorously stirred white suspension of 5,5,8,8-tetramethyl-6,7-dihydro-1H-cyclopenta[b]naphthalene (20.18 g, 89.2 mmol, 1.00 equiv.) in diethylether (250 mL) at −35° C. was added n-Butyl Lithium in hexane (36 ml, 90.0 mmol, 1.01 equiv.) to give a cold, cloudy light yellow mixture. The reaction became cloudy bright yellow after stirring 20 minutes. The reaction was stirred overnight, then was evaporated under vacuum, leaving dirty white solid. The solid was washed with pentane (100 mL) and the solid was filtered to give a bright white solid. The yield was 18.8 g (91%) bright white powder. ¹H NMR (THF-D₈) 7.46 (s, 2H), 6.50 (t, 1H), 5.81 (dt, 1H), 1.72 (S, 4H), 1.34 (S, 12H).

### Synthesis of 3,5,5,8,8-pentamethyl-6,7-dihydro-1H-cyclopenta[b]naphthalene (2)

To the colorless solution of iodomethane (7.47 g, 52.6 mmol, 2.0 equiv.) in Diethyl ether (200 ml) at −35° C. was added (5,5,8,8-tetramethyl-6,7-dihydro-1H-cyclopenta[b]naphthalen-1-yl) lithium (1) (6.12 g, 26.3 mmol, 1.0 equiv.) to give a cloudy white mixture. The reaction mixture was allowed stir at room temperature overnight. 1,2-dimethoxyethane (6 g) was added to the clear yellow reaction mixture results in the formation of white precipitate. The solvent was removed under vacuum, leaving white solid. The product was extracted with pentane (100 ml) and filtered results in the amber solution and white precipitate. The amber solution was dried under vacuum yields yellow viscous oil. The yield was 18.8 g (91%) bright white powder. 1H NMR (C₆D₆) 7.34 (dt, 2H), 6.71 (dt, 1H), 6.23 (dt, 1H), 3.29, (m, 1H), 1.65 (S, 4H), 1.30, (dt of dt, 12H), 1.15 (dt, 3H).

### Synthesis of (3,5,5,8,8-pentamethyl-6,7-dihydro-1H-cyclopenta[b]naphthalen-1-yl) lithium (3)

To a vigorously stirred white suspension of 3,5,5,8,8-pentamethyl-6,7-dihydro-3H-cyclopenta[b]naphthalene (2) (6.48 g, 27.0 mmol, 1.00 equiv.) in diethylether (250 mL) at −35° C. was added n-Butyl lithium in hexane (10.9 ml, 27.2 mmol, 1.01 equiv.) to give a cold, cloudy light yellow mixture. The reaction became cloudy bright yellow after stirring 20 minutes. The reaction was stirred overnight, then was evaporated under vacuum, leaving dirty white solid. The solid was washed with pentane (100 mL) and the solid was filtered to give a bright white solid. The yield was 6.30 g (95%) bright white powder. ¹H NMR (THF-D₈) 7.28 (dt, 2H), 6.30 (dt, 1H), 5.61 (dt, 1H), 2.43 (S, 3H), 1.72 (S, 4H), 1.35 (dt, 12H).

### Synthesis of bis(3,5,5,8,8-pentamethyl-6,7-dihydro-1H-cyclopenta[b]naphthalen-1-yl) zirconium dichloride (4)

To a vigorously stirred white suspension of zirconium tetrachloride (2.98 g, 12.8 mmol, 1.00 equiv.) in diethyl ether (200 mL) at −35° C. was added (3,5,5,8,8-pentamethyl-6,7-dihydro-1H-cyclopenta[b]naphthalen-1-yl) lithium (3) (6.30 g, 25.6 mmol, 2.00 equiv.) to give a cold, cloudy light yellow mixture. The reaction became cloudy bright yellow after stirring 20 minutes. The reaction was stirred overnight, then was evaporated under vacuum, leaving bright yellow solid. The solid was extracted with dichloromethane (100 mL) and the extracts were filtered to give a bright yellow solid. The solid was washed with cold pentane (50 mL) and dried under vacuum. The yield was 16.01 g (97%) bright yellow powder. ¹H NMR (CD₂Cl₂) 7.57 (S, 1H), 7.50 (D, 2H), 7.42 (s, 1H), 6.15 (dt, 1H), 5.89 (dt, 1H), 5.71 (dt, 1H), 5.50 (dt, 1H), 2.42 (s, 3H), 2.34 (s, 3H), 1.43 (m, 8H), 1.36 (m, 24H).

### Synthesis of bis(3,5,5,8,8-pentamethyl-6,7-dihydro-1H-cyclopenta[b]naphthalen-1-yl) zirconium dimethyl (Catalyst 1)

To a bright yellow suspension of bis(3,5,5,8,8-pentamethyl-6,7-dihydro-1H-cyclopenta[b]naphthalen-1-yl) zirconium dichloride (4) (4.11 g, 0.006 mol, 1.0 equiv) in 100 mL diethylether at −35° C. was added 3.28 M MeMgBr (10.7 ml, 0.032 mol, 5.0 equiv) in Et₂O to give a cold, cloudy yellow mixture. The reaction mixture was allowed to stir at room temperature overnight. Solvent was removed under vacuum. The product was extracted with pentane and dark brown solid was filtered out. Pentane was removed under vacuum resulted in the formation of pale yellow solid, 3.67 g, 87.2% 1H NMR (C₆D₆) 7.50 (S, 1H), 7.48 (S, 1H), 7.28 (dt, 1H), 7.22 (dt, 1H), 5.49 (dt, 1H), 5.44 (m, 3H), 2.26 (s, 3H), 2.26 (s, 3H), 1.62 (m, 8H), 1.35 (s, 3H), 1.32 (s, 6H), 1.31 (s, 3H), 1.30 (s, 3H), 1.29 (s, 6H), 1.28 (s, 3H), −0.32 (s, 1H), −0.89 (s, 3H), −1.50 (s, 1H).

### Catalyst Support:

Catalyst was supported by ES70 875 C silica and MAO.

### Procedure of Supportation of Catalyst 19:

MAO (42.5 g in 30 Wt % in toluene) was added to the celestir along with 200 ml of toluene. The solution was allowed to stir for two minutes. The catalyst, Catalyst 19 (1.1 g) was dissolved in 50 ml of toluene and added slowly drop by drop to the MAO solution. The reaction mixture was allowed to stir for an hour at room temperature. Then ES70 875 silica (35.2 g) was added to the above mixture and stir for another hour. The solid support was filtered and washed with 200 ml of pentane. Then the supported catalyst was dried under vacuum for 8 hours yield dry support. The supported catalyst was slurried in sonojell.

### Procedure of Supportation of Catalyst 1:

MAO (42.5 g in 30 Wt % in toluene) was added to the celestir along with 200 ml of toluene. The solution was allowed to stir for two minutes. The catalyst (1.15 g) was dissolved in 20 ml of toluene and added slowly drop by drop to the MAO solution. The reaction mixture was allowed to stir for an hour at room temperature. Then ES70 875 silica (35.2 g) was added to the above mixture and stirred for another hour. The solid support was filtered and washed with 200 ml of pentane. Then the supported catalyst was dried under vacuum for 8 hours to yield dry support.

TABLE 1

| | Comparative | Example | Example | Example | Example | Example |
|---|---|---|---|---|---|---|
| Run Condition # | Example | 1 | 2 | 3 | 4 | 5 |
| Catalyst # | EtInd | Cat. 19 | Cat. 19 | Cat. 19 | Cat. 1 | Cat. 1 |
| Catalyst Formulation | — | Support | Support | Support | Support | Support |
| PROCESS DATA | | | | | | |
| C6/C2 Ratio (mol %/mol %) | 0.014 | 0.010 | 0.010 | 0.013 | 0.010 | 0.010 |
| C2 conc. (mol %) | 69.9 | 69.5 | 70.0 | 70.1 | 70.1 | 70.0 |
| H2/C2 Ratio (ppm/mol %) | 5.0 | 4.3 | 2.1 | 9.3 | 4.3 | 2.2 |
| Rx. Pressure (psig) | 300 | 300 | 300 | 300 | 300 | 300 |
| Reactor Temp (F) | 185 | 185 | 185 | 185 | 185 | 185 |
| Residence Time (hr) | 5.9 | 5.1 | 4.5 | 4.9 | 5.9 | 4.9 |
| Catalyst Feed (g solids/hr) | 0.405 | 0.177 | 0.147 | 0.177 | 0.185 | 0.185 |
| Cat Activity (g poly/g cat) | 1000 | 2528 | 3519 | 2696 | 2127 | 2561 |
| Product Data | | | | | | |
| Melt Index (MI) | 34.75 | 0.51 | 0.05 | 7.23 | 8.64 | 2.28 |
| HLMI | 627.81 | 34.73 | 8.04 | 233.99 | 233.73 | 83.79 |
| HLMI/MI Ratio (MIR) | 18.07 | 67.44 | 154.54 | 32.36 | 27.04 | 36.76 |
| Gradient Density | 0.9455 | 0.9408 | 0.9338 | 0.9434 | 0.9481 | 0.9453 |
| Bulk Density | 0.4197 | 0.4278 | 0.4680 | 0.3955 | 0.3413 | 0.3584 |

Polyethylene (PE) resins used as comparative and inventive examples were generated in a 12″ diameter small gas phase reactor in continuous operation. Table 1 lists the polymerization conditions employed. The “EtInd” comparative catalyst of Table 1 refers to rac-meso-bis(1-ethyl indenyl) 2 zirconium dimethyl.

The PE resins, in granular forms from the gas phase reactor, were dry blended in a tumble mixer with the following additive: 500 ppm of Irganox™-1076, 1,000 ppm of Irgafos™ 168 and 600 ppm of Dynamar™ FX5920A, then compounded on lab scale twin screw extruders (Leistritz 27 or Leistritz 18) under typical PE compounding conditions. The resulting stabilized PE pellets were characterized for QC properties and composition characteristics. Table 2 lists the product characterization results.

Density testing followed ASTM D1505, column density. Samples were molded under ASTM D4703-10a, Procedure C, then conditioned under ASTM D618-08 (23°±2° C. and 50±10% Relative Humidity) for 40 hours before testing.

Melt Index (MI) and High Load Melt Index (HLMI or FI) followed ASTM D-1238 at 190° C. under 2.16 kg or 21.6 kg, respectively.

Rheology characterization employed Small Amplitude Oscillatory Shear testing on a ARES-G2 instrument at 190° C. at 4 to 6% strain over 0.01 to 626 rad/s frequency range. The resulting data were fitted by Cross equation to obtain viscosity, time and power law constants, A1, A2 and A3. G′/G″ at 0.1 s⁻¹ is the ratio of storage to loss modulus at 0.1 s⁻¹ frequency. Shear Thinning Index STI0.1/100 is the ratio of complex viscosity at 0.1 s⁻¹ over that at 100 s⁻¹.

TABLE 2
Product characteristics

| | Comparative | Ex. #1 | Ex. #2 | Ex. #3 | Ex. #4 | Ex. #5 |
|---|---|---|---|---|---|---|
| | EtInd | Cat. 19 | Cat. 19 | Cat. 19 | Cat. 1 | Cat. 1 |
| Density (g/cm³) | 0.9455 | 0.9408 | 0.9338 | 0.9434 | 0.9481 | 0.9453 |
| I₂ (g/10 min) | 34.75 | 0.51 | 0.05 | 7.23 | 8.64 | 2.28 |
| I₂₁ (g/10 min) | 627.81 | 34.73 | 8.04 | 233.99 | 233.73 | 83.79 |
| MIR | 18.07 | 67.44 | 154.54 | 32.36 | 27.04 | 36.76 |
| Phase angle at 10 kPa, | 73.6 | 47.9 | 40.7 | 61.2 | 63.3 | 56.2 |
| degree | | | | | | |
| A1 (Pa · s) | 266 | 236,987 | 11,331,400 | 3,988 | 6135 | 21406 |
| A2 (s) | 0.15 | 199.2 | 9,528.4 | 2.76 | 100.0 | 36.9 |
| A3 | 0.23 | 0.52 | 0.61 | 0.39 | 0.31 | 0.41 |
| G′/G″@0.1 s⁻¹ | 0.26 | 0.73 | 1.27 | 0.23 | 0.34 | 0.43 |
| STI0.1/100 | 2.34 | 30.7 | 60.8 | 6.20 | 5.77 | 11.0 |
| Mn-IR | 5265 | 16,084 | 22,946 | 9472 | 10,623 | 13,806 |
| Mw | 42723 | 110,633 | 167,453 | 70,865 | 74,826 | 87,187 |
| Mz | 708171 | 818,856 | 815,619 | 937,279 | 1,465,158 | 996,579 |
| Mz + 1 | 3536485 | 3,944,375 | 3,524,859 | 4,414,342 | 4,924,345 | 4,291,490 |
| Mw/Mn | 8.11 | 6.88 | 7.30 | 7.48 | 7.04 | 6.31 |
| Mz/Mw | | | | | | |
| Bulk C6 (wt. %) | 2.94 | 2.42 | 2.29 | 2.69 | 1.76 | 1.97 |
| g′(Vis Ave.) | | 0.926 | 0.897 | 0.954 | 0.926 | 0.914 |
| Tw | ~ | 91.5 | 91.7 | 87.4 | 90.2 | 91.6 |
| Tmedian | ~ | 94.1 | 94.2 | 91.9 | 94.5 | 95.0 |
| T₇₅-T₂₅ | ~ | 3.0 | 2.3 | 7.7 | 4.7 | 2.9 |
| Cw, % mol | ~ | 1.69 | 1.67 | 2.72 | 2.24 | 1.83 |
| Cmed, % mol | ~ | 0.56 | 0.55 | 0.95 | 0.5 | 0.4 |
| CDBI, % | ~ | 58.07 | 63.89 | 50.61 | 44.5 | 42.96 |

FIG. 1 is a graph illustrating overlay of complex viscosity of ethylene-hexene copolymers with Catalyst 19 in gas phase reactor.

FIG. 2 is a graph illustrating overlay of extensional viscosity of ethylene-hexene copolymers with Catalyst 19 in gas phase reactor. The sharp upturn of the extensional viscosity lines of inventive polymers at large times indicates long chain branching.

FIG. 3 is a Van Gurp Palmen plot of ethylene-hexene copolymers from different catalysts in gas phase reactor. As discussed above, the inflection in the otherwise generally negatively-sloped curves of inventive polymers illustrates long chain branching.

Overall, polyethylenes of the present disclosure can be characterized as having a unique balance of chemical, physical, and mechanical properties relative to conventional MDPE, conventional LLDPE, and other conventional polyethylene grades. For example, polyethylenes of the present disclosure exhibit a density that is traditionally associated with MDPE (or HDPE) while also having long chain branching and low melt index. The long chain branching and low melt index can be obtained even though (1) catalysts of the present disclosure can provide low comonomer incorporation and (2) polyethylenes of the present disclosure, in some embodiments, do not have BOCD. Nonetheless, the polyethylene copolymers of the present disclosure can still surprisingly provide improved film properties even though the polyethylene copolymers (1) have good processability for film formation and (2) catalysts of the present disclosure provide high molecular weight polyethylenes. Moreover, and as compared to traditional LLDPE and other conventional polyethylene grades, polyethylenes of the present disclosure can have a low melt index, higher viscosity at low shear rates (e.g., due to low comonomer incorporation in general and low comonomer content in high molecular weight portions of the polyethylene copolymer, in particular), and improved processability, for example, improved extrudability (e.g., due to long chain branching) while maintaining good bubble stability during fabrication processes. For example, catalysts and polymerizations of the present disclosure can provide MDPEs (or HDPEs) having low melt rates at shear rates typically encountered during extrusion and melt processing as well as high melt viscosities at lower shear rates (such as at zero shear viscosity) for improved bubble stability during processing. Such advantages can be realized even though catalysts of the present disclosure provide high molecular weight polyethylene copolymers. For example, catalysts of the present disclosure provide improved molecular weight capability as compared to conventional bisindenyl zirconocenes. Such high molecular weight of polyethylene copolymers (in addition to lack of BOCD) can provide improved toughness properties of polyethylene copolymers, as compared to conventional MDPEs (or HDPEs).

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

All priority documents are herein fully incorporated by reference for all purposes and for all jurisdictions in which such incorporation is permitted and to the extent such description is consistent with the present disclosure. Further, all documents and references cited herein, including testing procedures, publications, patents, journal articles, etc. are herein fully incorporated by reference for all jurisdictions in which such incorporation is permitted and to the extent such description is consistent with the disclosure.

Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the claimed invention, additionally, the phrases do not exclude impurities and variances normally associated with the elements and materials used.

While the claimed invention is described with respect to a number of embodiments and examples, those skilled in the art, having benefit of this disclosure, will appreciate that other embodiments can be devised which do not depart from the scope and spirit of the disclosure.

What is claimed is:

1. An unbridged catalyst compound represented by Formula (I): 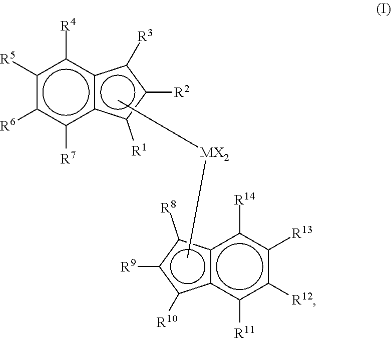
wherein:
M is a group 4 metal;
each of R¹, R², R³, R⁴, R⁵, R⁶, R⁷, R⁸, R⁹, R¹⁰, R¹¹, R¹², R¹³ and R¹⁴ is independently hydrogen, substituted or unsubstituted hydrocarbyl, a substituted or unsubstituted heteroatom, or a substituted or unsubstituted heteroatom-containing group, or one or more of R¹ and R², R⁴ and R⁵, R⁵ and R⁶, R⁶ and R⁷, R⁹ and R¹⁰, R¹¹ and R¹², R¹² and R¹³, and R¹³ and R¹⁴ are joined to form a substituted or unsubstituted completely saturated ring or a substituted or unsubstituted aromatic ring, wherein at least one of R⁴ and R⁵, R⁵ and R⁶, or R⁶ and R⁷ are joined to form a first substituted or unsubstituted completely saturated ring fused to the indenyl ring and at least one of R¹¹ and R¹², R¹² and R¹³, or R¹³ and R¹⁴ are joined to form a second substituted or unsubstituted completely saturated ring fused to the indenyl ring, wherein if R¹² and R¹³ are joined to form a substituted or unsubstituted completely saturated ring, then R⁹ is not substituted or unsubstituted hydrocarbyl, wherein if R⁵ and R⁶ are joined to form a substituted or unsubstituted completely saturated ring, then R² is not substituted or unsubstituted hydrocarbyl; and
each X is independently a halide, a substituted or unsubstituted hydrocarbyl, hydride, amide, substituted or unsubstituted alkoxide, sulfide, phosphide, or a combination thereof, or two of X are joined together to form a substituted or unsubstituted metallocycle ring, or two of X are joined to form a chelating ligand, a diene ligand, or an alkylidene.

2. The unbridged catalyst compound of claim 1, wherein the unbridged catalyst compound is represented by Formula (II): 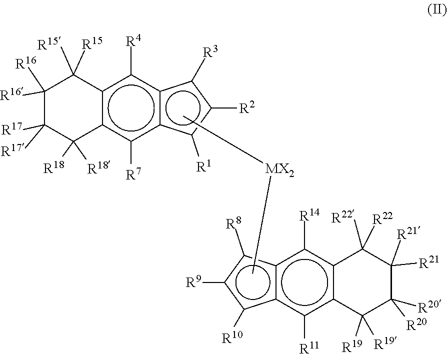
wherein:
M is a group 4 metal;
each of R¹, R², R³, R⁴, R⁷, R⁸, R⁹, R¹⁰, R¹¹, R¹⁴, R¹⁵, R^{15′}, R¹⁶, R^{16′}, R¹⁷, R^{17′}, R¹⁸, R^{18′}, R¹⁹, R^{19′}, R²⁰, R^{20′}, R²¹, R^{21′}, R²², and R^{22′} is independently hydrogen, a substituted or unsubstituted hydrocarbyl, a substituted or unsubstituted heteroatom, or a substituted or unsubstituted heteroatom-containing group, wherein at least one of R² or R⁹ is not substituted or unsubstituted hydrocarbyl; and
each X is independently a halide, a substituted or unsubstituted hydrocarbyl, a hydride, an amide, a substituted or unsubstituted alkoxide, a sulfide, a phosphide, or a combination thereof, or two of X are joined together to form a substituted or unsubstituted metallocycle ring, or two of X are joined to form a chelating ligand, a diene ligand, or an alkylidene.

3. The unbridged catalyst compound of claim 2, wherein each X of Formula (II) is halide and each of R³, R¹⁰, R¹⁵, R^{15′}, R¹⁸, R^{18′}, R¹⁹, R^{19′}, R²², and R^{22′} of Formula (II) is independently C₁-C₁₀ alkyl.

4. The unbridged catalyst compound of claim 3, wherein each of R¹, R², R⁴, R⁷, R⁸, R⁹, R¹¹, R¹⁴, R¹⁶, R^{16′}, R¹⁷, R^{17′}, R²⁰, R^{20′}, R²¹, and R^{21′} in formula (II) is hydrogen.

5. The unbridged catalyst compound of claim 2, wherein each X of Formula (II) is independently C₁-C₄ alkyl or halide, and each of R¹, R², R³, R⁸, R⁹, and R¹⁰ is hydrogen.5.
The unbridged catalyst compound claim 2, wherein (i) each X of Formula (II) is independently C₁-C₄ alkyl, (ii) one of of R¹, R², and R³ of Formula (II) is C₁-C₁₀ alkyl and the remainder of R¹, R², and R³ are each hydrogen; and (iii) one of R⁸, R⁹, and R¹⁰ of Formula (II) is C₁-C₁₀ alkyl and the remainder of R⁸, R⁹, and R¹⁰ are each hydrogen.

6. The unbridged catalyst compound of claim 5, wherein each of R³ and R¹⁰ is independently methyl or ethyl.

7. The unbridged catalyst compound of claim 5, wherein each of R¹⁵, R^{15′}, R¹⁸, R^{18′}, R¹⁹, R^{19′}, R²², and R^{22′} of Formula (II) is independently C₁-C₁₀ alkyl and/or wherein each of R¹, R², R⁴, R⁷, R⁸, R⁹, R¹¹, R¹⁴, R¹⁶, R^{16′}, R¹⁷, R^{17′}, R²⁰, R^{20′}, R²¹, and R^{21′} of Formula (II) is hydrogen.

8. The unbridged catalyst compound of claim 2, wherein M of Formula (II) is zirconium.

9. The unbridged catalyst compound of claim 2, wherein the unbridged catalyst compound of Formula (II) is selected from the group consisting of:

| | | | |
|---|---|---|---|
| 1 | 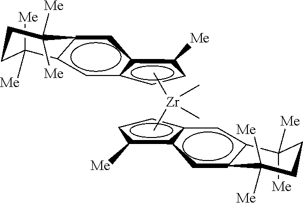 | 2 | 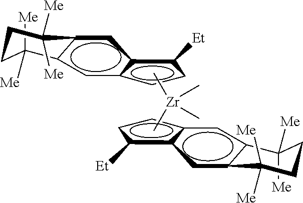 |
| 3 | 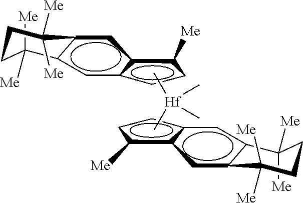 | 4 | 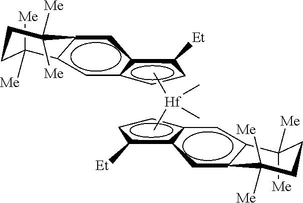 |
| 5 | 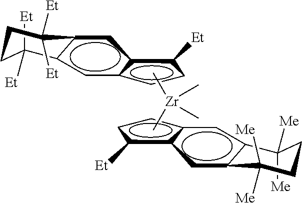 | 6 | 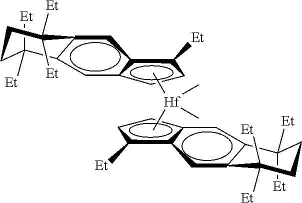 |
| 7 | 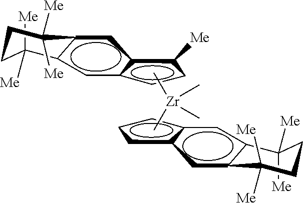 | 8 | 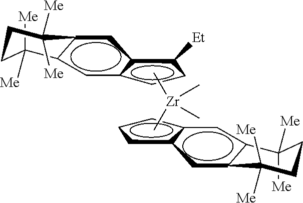 |
| 9 | 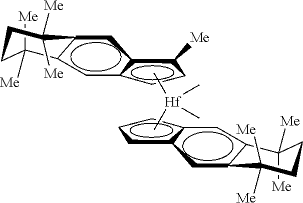 | 10 | 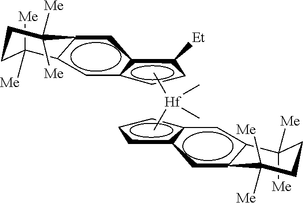 |
| 11 | 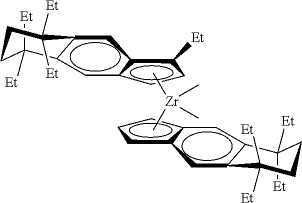 | 12 | 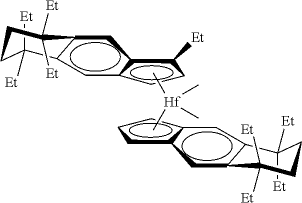 |
| 13 | 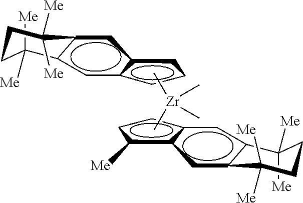 | 14 | 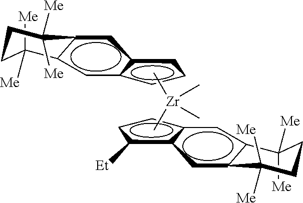 |
| 15 | 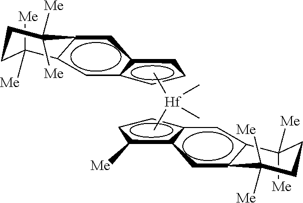 | 16 | 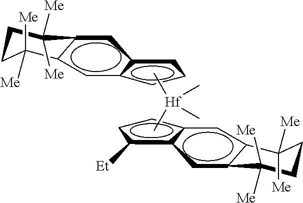 |
| 17 | 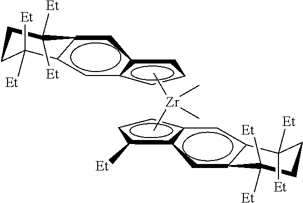 | 18 | 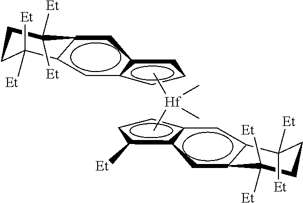 |
| 19 | 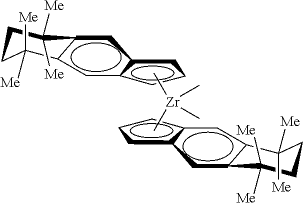 | 20 | 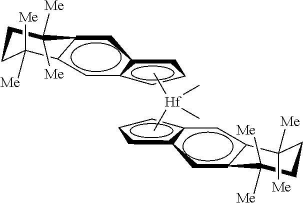 |
| 21 | 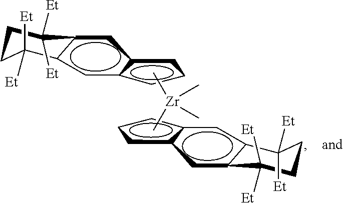 | 22 | 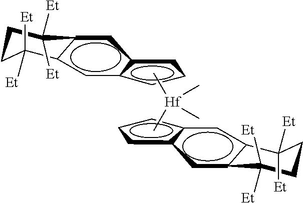 |

10. The unbridged catalyst compound of claim 9, wherein the unbridged catalyst compound is:

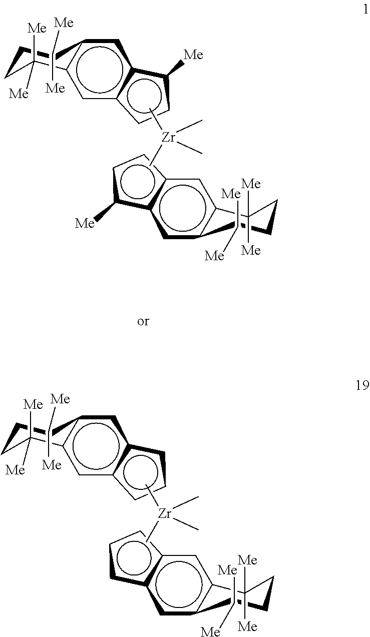

11. The unbridged catalyst of claim 3, wherein the unbridged catalyst compound is selected from the group consisting of:

| | | | |
|---|---|---|---|
| 1 | 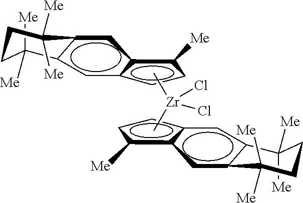 | 2 | 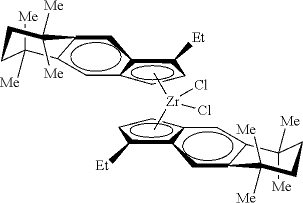 |
| 3 | 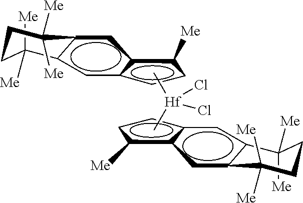 | 4 | 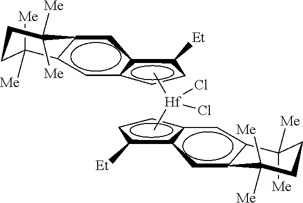 |
| 5 | 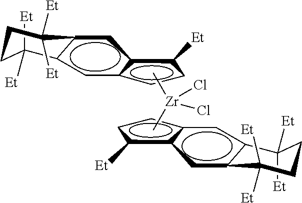 | 6 | 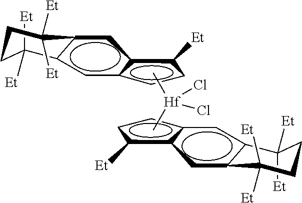 |
| 7 | 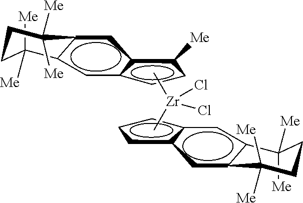 | 8 | 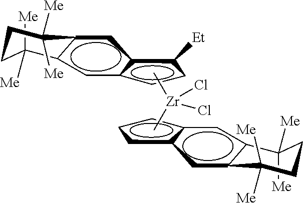 |
| 9 | 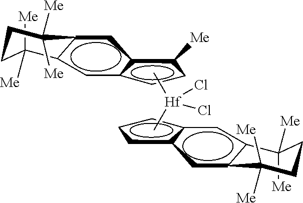 | 10 | 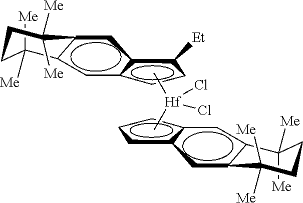 |
| 11 | 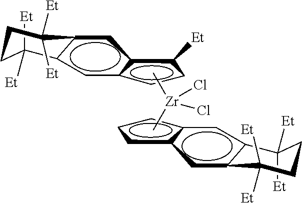 | 12 | 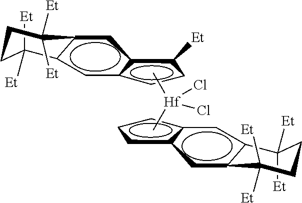 |
| 13 | 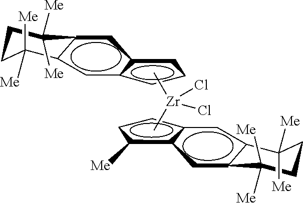 | 14 | 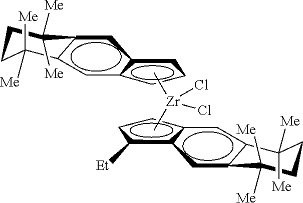 |
| 15 | 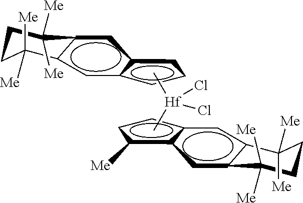 | 16 | 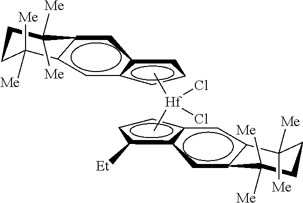 |
| 17 | 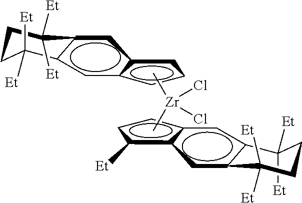 | 18 | 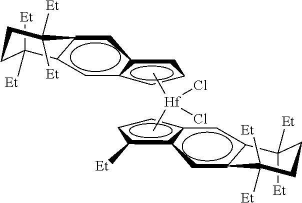 |
| 19 | 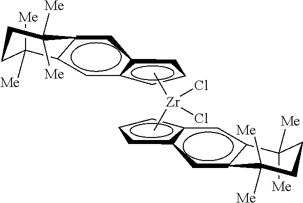 | 20 | 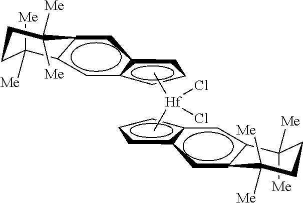 |
| 21 | 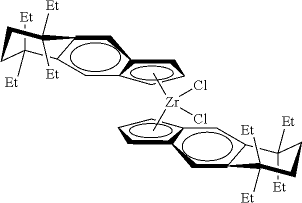 | 22 | 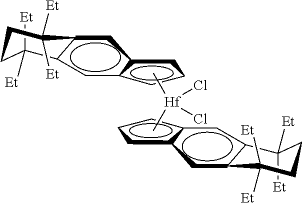 |

12. A catalyst system comprising:
a support material;
optionally, an activator; and
the unbridged catalyst compound of claim 1.

13. A process for producing a polyethylene composition, comprising:
introducing, under polymerization conditions, ethylene and a C₃-C₄₀ alpha-olefin with the catalyst system of claim 12 to a reactor, and forming a polyethylene copolymer, wherein the polyethylene copolymer has:
about 95 wt % or greater ethylene-derived units and a remainder balance of C₃-C₂₀ comonomer-derived units, on the basis of total mass of ethylene-derived and comonomer-derived units;
a density of about 0.925 g/cm³ to about 0.955 g/cm³,
a weight average molecular weight (Mw) of about 60,000 g/mol to about 300,000 g/mol,
a number average molecular weight (Mn) of about 7,500 g/mol to about 50,000 g/mol,
a z-average molecular weight (Mz) of about 700,000 g/mol to about 2,000,000 g/mol,
a melt index (MI, 190° C., 2.16 kg) of about 0.3 g/10 min to about 11 g/10 min,
a melt index ratio (MIR, the ratio of high load melt index to melt index (HLMI/MI)) of about 20 to about 200, and
a shear thinning index (STI0.1/100) greater than 5.

14. The process of claim 13, wherein the polyethylene copolymer has a composition distribution breadth index (CDBI) of about 40% to about 65%.

15. The process of claim 13, wherein the polyethylene copolymer is characterized by having long chain branching.

16. The process of claim 15, wherein the long chain branching of the polyethylene copolymer is characterized by one or more of the following:
(a) a g′vis value of about 0.85 to about 0.97;
(b) an inflection point in a Van Gurp Palmen plot of phase angle vs. complex modulus;
(c) MIR within the range from 25 to 200; and
(d) shear thinning index (STI0.1/100) within the range from 6 to 65.

17. A polyethylene copolymer, comprising:
about 95 wt % or greater ethylene-derived units and a remainder balance of C₃-C₂₀ comonomer-derived units, on the basis of total mass of ethylene-derived and comonomer-derived units;
the polyethylene copolymer having:
a density of about 0.925 g/cm³ to about 0.955 g/cm³,
a weight average molecular weight (Mw) of about 50,000 g/mol to about 300,000 g/mol,
a number average molecular weight (Mn) of about 5,000 g/mol to about 50,000 g/mol,
a z-average molecular weight (Mz) of about 300,000 g/mol to about 2,000,000 g/mol,
a melt index of about 0.3 g/10 min to about 11 g/10 min,
a melt index ratio of about 20 to about 200, and
a shear thinning index (STI0.1/100) greater than 5.

18. The polyethylene copolymer of claim 17, further having a CDBI within the range from about 40% to about 65%.

19. The polyethylene copolymer of claim 17 or claim 18, wherein the polyethylene copolymer is characterized by having long chain branching.

20. The polyethylene copolymer of claim 19, wherein the long chain branching of the polyethylene copolymer is characterized by one or more of the following:
(i) a g′vis value of about 0.85 to about 0.97;
(ii) an inflection point in a Van Gurp Palmen plot of phase angle vs. complex modulus;
(iii) MIR within the range from 25 to 200; and
(iv) shear thinning index (STI0.1/100) within the range from 6 to 65.

21. The polyethylene copolymer of claim 17, having one or more of the following:
(a) density of about 0.94 g/cm³ to about 0.955 g/cm³;
(b) about 97 wt % to about 98.5 wt % ethylene-derived units;
(c) MIR of about 120 to about 180;
(d) molecular weight distribution (Mw/Mn) of about 6 to about 7.5;
(e) Mw within the range from about 120,000 to about 200,000 g/mol;
(f) Mz within the range from about 800,000 to about 1,000,000 g/mol; or
(g) a shear thinning index (ST10.1/100) of about 5 to about 65.

22. The polyethylene copolymer of claim 21, wherein the polyethylene copolymer has a shear thinning index (STI0.1/100) of about 25 to about 35.

23. The polyethylene copolymer of claim 21, wherein the polyethylene copolymer has a shear thinning index (STI0.1/100) of about 55 to about 65.

24. The polyethylene copolymer of claim 21, wherein the copolymer is made using the catalyst system of claim 12.
